(19) United States
(12) Patent Application Publication
(10) Pub. No.: US 2013/0149514 A1
(43) Pub. Date: Jun. 13, 2013

(54) INSULATING SHEET, METHOD OF MANUFACTURING THE SAME, AND METHOD OF MANUFACTURING STRUCTURE USING THE INSULATING SHEET

(71) Applicant: Katsura Hayashi, Kirishima-shi (JP)

(72) Inventor: Katsura Hayashi, Kirishima-shi (JP)

(73) Assignee: KYOCERA CORPORATION, Kyoto-shi, Kyoto (JP)

(21) Appl. No.: 13/813,368

(22) PCT Filed: Jul. 26, 2011
(86) PCT No.: PCT/JP2011/066928

§ 371 Date: Feb. 19, 2013

(30) Foreign Application Priority Data
Jul. 30, 2010 (JP) 2010-171452

(51) Int. Cl. H01B 3/02

(52) U.S. Cl. CPC H01B 3/02
USPC 428/213; 428/323; 427/180; 427/202; 156/239

(57) ABSTRACT

An insulating sheet includes a resin sheet, and an insulating layer disposed on the resin sheet, wherein the insulating layer includes an inorganic insulating layer, and the inorganic insulating layer includes first inorganic insulating particles which have a particle size of not less than 3 nm and not greater than 110 nm and which are bonded to each other.

### TECHNICAL FIELD

The present invention relates to an insulating sheet used for various things such as electronic devices (for example, various audio visual devices, household electrical appliances, communication devices, a computer and peripheral devices thereof), a transport aircraft, buildings and the like, a method of manufacturing the insulating sheet, and a method of manufacturing a structure using the insulating sheet.

### BACKGROUND ART

In the related art, a structure in which electronic components are mounted on a wiring board is used as a mounting structure of an electronic device.

Japanese Unexamined Patent Publication JP-A 2-253941 (1990) discloses a wiring board manufactured by using a ceramic layer formed by thermal spraying ceramics onto metal foil.

Since the ceramic layer is formed by thermal spraying ceramics under high temperature conditions, ceramic particles grow under the high temperature conditions so that a particle size easily becomes large and a flatness of the ceramic layer is easily degraded. In addition, since the ceramic layer is formed on the metal foil which tends to be rolled, flatness of the ceramic layer is easily degraded and defects occur when forming wiring on the ceramic layer. As a result, electrical reliability of the wiring board is easily degraded.

Accordingly, it is desirable to provide a structure such as a wiring board with improved electrical reliability.

### SUMMARY OF INVENTION

An insulating sheet in accordance with one embodiment of the invention includes a resin sheet, and an insulating layer disposed on the resin sheet. The insulating layer includes an inorganic insulating layer. The inorganic insulating layer includes first inorganic insulating particles which have a particle size of not less than 3 nm and not greater than 110 nm and which are bonded to each other.

A method of manufacturing an insulating sheet in accordance with one embodiment of the invention includes a step of directly or indirectly applying inorganic insulating sol, including first inorganic insulating particles having a particle size of not less than 3 nm and not greater than 110 nm, onto a resin sheet; and a step of bonding the first inorganic insulating particles to each other to form an inorganic insulating layer by heating the first inorganic insulating particles at a temperature of lower than a melting point of a resin included in the resin sheet.

A method of manufacturing a structure in accordance with one embodiment of the invention includes a step of laminating the insulating sheet mentioned above on a support member via a first resin layer including an uncured thermosetting resin so that the resin sheet becomes an outermost layer; a step of adhering the inorganic insulating layer to the support member via the first resin layer by heating the first resin layer at a temperature of not lower than a curing start temperature of the thermosetting resin and lower than a melting point of a resin included in the resin sheet; and a step of removing the resin sheet from the inorganic insulating layer.

A method of manufacturing a structure in accordance with one embodiment of the invention includes a step of removing the resin sheet from the insulating layer; and a step of forming a conductive layer on a main surface of the insulating layer which main surface is disposed on a resin sheet side.

According to the configuration described above, it is possible to obtain an insulating sheet with high flatness. Accordingly, it is possible to obtain a structure with improved electrical reliability.

### BRIEF DESCRIPTION OF DRAWINGS

FIG. 1(a) is a cross-sectional view of an insulating sheet according to a first embodiment of the invention which is cross-sectioned in a thickness direction, and FIG. 1(b) is an enlarged cross-sectional view of an R1 portion of FIG. 1(a);

FIG. 2(a) is a cross sectional view which is cross-sectional in a plan direction along line I-I of FIG. 1(b), and FIG. 2(b) schematically shows a bonding state of two first inorganic insulating particles;

FIG. 3(a) is a cross-sectional view of a mounting structure manufactured using the insulating sheet shown in FIG. 1 which is cross-sectioned in a thickness direction thereof, and FIG. 3(b) is an enlarged cross-sectional view of an R2 portion of FIG. 3(a);

FIG. 4(a) and FIG. 4(b) are cross-sectional views which describe a step of manufacturing the insulating sheet shown in FIG. 1 and which are cross-sectioned in the thickness direction, and FIG. 4(c) is an enlarged cross-sectional view of an R3 portion of FIG. 4(b);

FIG. 5(a) is a cross-sectional view which describes a step of manufacturing the insulating sheet shown in FIG. 1 and which is cross-sectioned in the thickness direction, and FIG. 5(b) is an enlarged cross-sectional view of an R4 portion of FIG. 5(a);

FIG. 6(a) is a cross-sectional view which describes a step of manufacturing the insulating sheet shown in FIG. 1 and which is cross-sectioned in the thickness direction, and FIG. 6(b) is an enlarged cross-sectional view of an R5 portion of FIG. 6(a);

FIG. 7(a) is a cross-sectional view which describes a step of manufacturing the insulating sheet shown in FIG. 1 and which is cross-sectioned in the thickness direction, and FIG. 7(b) is an enlarged cross-sectional view of an R6 portion of FIG. 7(a);

FIG. 8(a) to FIG. 8(c) are cross-sectional views which describe a step of manufacturing a wiring board using the insulating sheet shown in FIG. 1 and which is cross-sectioned in the thickness direction;

FIG. 9(a) and FIG. 9(b) are cross-sectional views which describe a step of manufacturing the wiring board using the insulating sheet shown in FIG. 1 and which is cross-sectioned in the thickness direction;

FIG. 10(a) and FIG. 10(b) are enlarged cross-sectional views of a portion corresponding to an R7 portion of FIG. 9(b) which describe a step of manufacturing the wiring board using the insulating sheet shown in FIG. 1;

FIG. 11(a) is an enlarged cross-sectional view of a portion corresponding to an R7 portion of FIG. 9(b) which describes a step of manufacturing the wiring board using the insulating sheet shown in FIG. 1, and FIG. 11(b) is a cross-sectional view which describes a step of manufacturing the wiring board using the insulating sheet shown in FIG. 1 and which is cross-sectioned in the thickness direction;

FIG. 12(a) is a cross-sectional view of an insulating sheet according to a second embodiment of the invention which is cross-sectioned in a thickness direction thereof, and FIG. 12(b) is an enlarged cross-sectional view of an R8 portion of FIG. 12(a);

FIG. 13(a) is a cross-sectional view of an insulating sheet according to a third embodiment of the invention which is cross-sectioned in a thickness direction thereof, and FIG. 13(b) is an enlarged cross-sectional view of an R9 portion of FIG. 13(a); and

FIG. 14(a) is a cross-sectional view in which a mounting structure according to a fourth embodiment of the invention is cross-sectioned in a thickness direction thereof, FIG. 14(b) is a cross-sectional view which is cross-sectioned in a thickness direction of an insulating sheet used for manufacture of a mounting structure shown in FIG. 14(a), and FIG. 14(c) is a cross-sectional view which describes a step of manufacturing the mounting structure shown in FIG. 14(a) and which is cross-sectioned in the thickness direction.

### DESCRIPTION OF EMBODIMENTS

### First Embodiment

(Insulating Sheet)

Hereinafter, an insulating sheet according to a first embodiment of the invention will be described in detail with reference to the drawings.

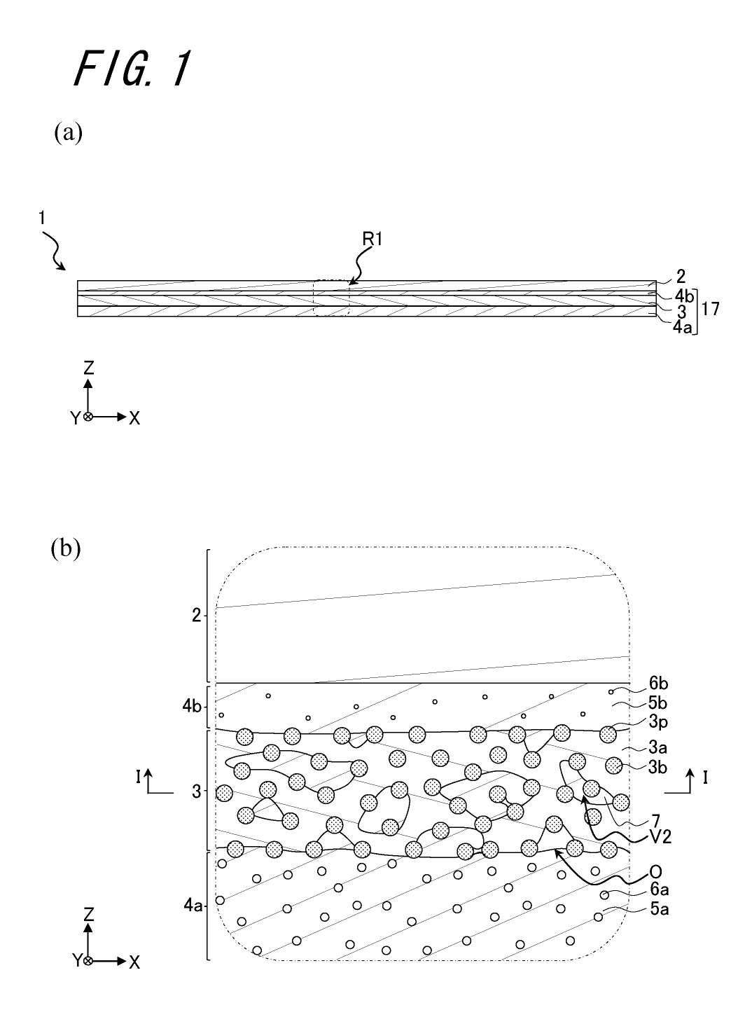

An insulating sheet 1 shown in FIG. 1(a) is used for manufacturing a wiring board 10 which will be described later, for example. The insulating sheet 1 includes a resin sheet 2, an inorganic insulating layer 3 disposed on the resin sheet 2, a first resin layer 4a disposed on the inorganic insulating layer 3, and a second resin layer 4b disposed between the resin sheet 2 and the inorganic insulating layer 3. The inorganic insulating layer 3, the first resin layer 4a and the second resin layer 4b in the insulating sheet 1 constitute an insulating layer 17 that remains in the wiring board 10 when manufacturing the wiring board 10 which will be described later.

The resin sheet 2 supports the inorganic insulating layer 3 when handling the insulating sheet 1, is removed from the inorganic insulating layer 3 when manufacturing the wiring board, and is formed in a flat plate shape, for example. The resin sheet 2 is formed of a thermoplastic resin such as a polyester resin or a polyethylene resin, and a polyethylene terephthalate resin or a polyethylene naphthalate resin can be used as a polyester resin, for example. It is desirable to use a film-like sheet in which a length direction of each linear molecule chain is in the same direction, for the resin sheet 2 formed of a thermoplastic resin. It is possible to improve flatness of the resin sheet 2 by using a film-like sheet formed of a thermoplastic resin as described above.

In addition, a thickness of the resin sheet 2 is set to be not less than 8 μm and not greater than 100 μm, for example, a Young's modulus of the resin sheet 2 is set to be not less than 7 GPa and not greater than 12 GPa, for example, a coefficient of thermal expansion of the resin sheet 2 in a planar direction is set to be not less than 20 ppm/° C. and not greater than 70 ppm/° C., and a melting point of the resin sheet 2 is set to be not lower than 200° C. and not higher than 260° C., for example.

In addition, the Young's modulus of the resin sheet 2 is measured using Nano Indenter XP/DCM manufactured by MTS Systems Corporation. Further, the coefficient of thermal expansion of the resin sheet 2 is measured with a measuring method based on JIS K 7197-1991 using a commercially available TMA apparatus. Moreover, the melting point of the resin sheet 2 is measured with a measuring method based on ISO 12086-2:2006.

The inorganic insulating layer 3 is adhered to a wiring board when manufacturing the wiring board, is made to remain on the wiring board to be a main part of an insulating layer, and is formed in a flat plate shape, for example. The inorganic insulating layer 3 is formed of an inorganic insulating material such as silicon oxide, aluminum oxide, titanium oxide, magnesium oxide or zirconium oxide. It is desirable to be formed of silicon oxide among these, and particularly it is desirable to be formed of silicon oxide in an amorphous state, from a viewpoint of a low dielectric loss tangent and a low coefficient of thermal expansion. As a result, compared to silicon oxide in a crystal state in which anisotropy of the coefficient of thermal expansion easily occurs because of a molecular structure, by using silicon oxide in an amorphous state in which it is difficult for anisotropy of the coefficient of thermal expansion to occur, it is possible to obtain more even contraction of the inorganic insulating layer 3 in each direction when the inorganic insulating layer 3 is cooled after being heated, and to reduce generation of a crack in the inorganic insulating layer 3. A crystal phase region of the silicon oxide in the amorphous state is set to be less than 10% by volume, for example, and it is desirable to be set to be less than 5% by volume

Herein, a volume ratio of the crystal phase region of the silicon oxide is measured as follows. First, a plurality of comparative specimens including different ratios of 100% crystallized specimen powder and amorphous powder are manufactured, and by measuring the comparative specimens with an X-ray diffraction method, a standard curve showing a relative relationship between the measured value and a volume ratio of the crystal phase region. Next, an inspection specimen which is a measuring object is measured with the X-ray diffraction method, and a volume ratio of a crystal phase region of the inspection specimen is measured by calculating a volume ratio of a crystal phase region from the measured value, by comparing the measured value and a standard curve.

In addition, a thickness of the inorganic insulating layer 3 is set to be not less than 3 μm and not greater than 100 μm, for example. A Young's modulus of the inorganic insulating layer 3 is set to be not less than 20 GPa and not greater than 50 GPa, for example, and/or is set to be not less than four times and not greater than ten times as much as the Young's modulus of the resin sheet 2. In addition, coefficients of thermal expansion of the inorganic insulating layer 3 in a planar direction and a thickness direction are set to be not less than 0 ppm/° C. and not greater than 7 ppm/° C., for example. In addition, the coefficient of thermal expansion of the inorganic insulating layer 3 in the planar direction is set to be not less than 0% and not greater than 20% of the coefficient of thermal expansion of the resin sheet 2 in the planar direction, for example. In addition, a dielectric loss tangent of the inorganic insulating layer 3 is set to be not less than 0.0004 and not greater than 0.01, for example.

The Young's modulus and the coefficient of thermal expansion of the inorganic insulating layer 3 are measured in the same manner as the resin sheet 2 described above. In addition, the dielectric loss tangent of the inorganic insulating layer 3 is measured with a resonator method based on JIS R 1627-1996.

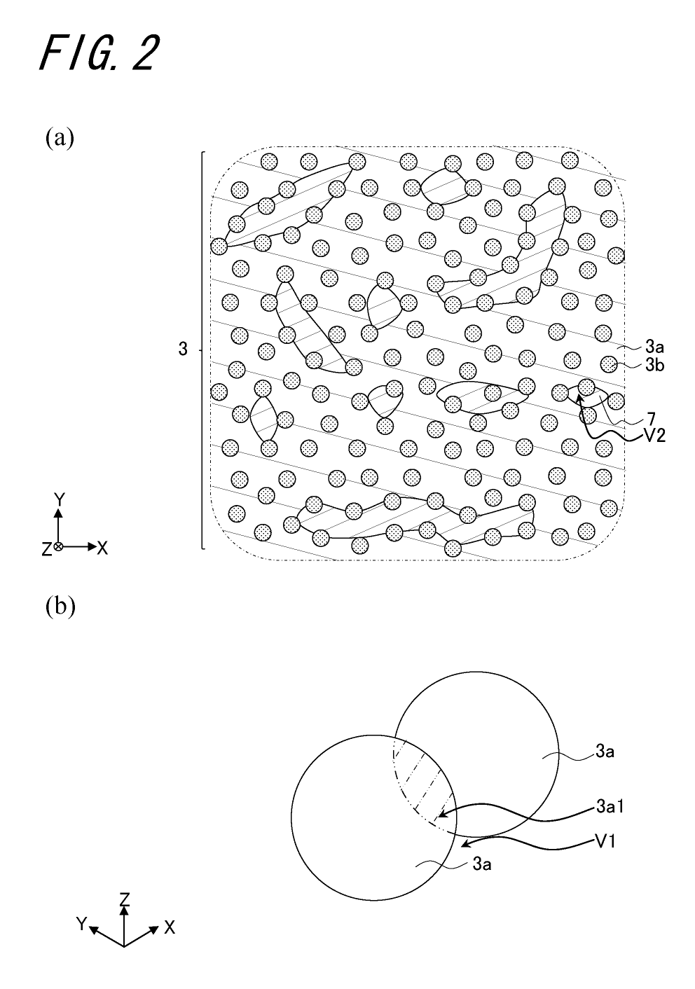

As shown in FIGS. 1(b) to 2(b), the inorganic insulating layer 3 of the embodiment includes first inorganic insulating particles 3a which are bonded to each other, and second inorganic insulating particles 3b which are adhered to each other via the first inorganic insulating particles 3a, and the particle size of the second inorganic insulating particles 3b is larger than the particle size of the first inorganic insulating particles 3a. The first inorganic insulating particles 3a and the second inorganic insulating particles 3b are formed of the inorganic insulating material configuring the inorganic insulating layer 3 described above. In addition, the first inorganic insulating particles 3a and the second inorganic insulating particles 3b are identified by observing a cross section of the inorganic insulating layer 3 with a field-emission electronic microscope.

The particle size of the first inorganic insulating particles 3a is set to be not less than 3 nm and not greater than 110 nm. Since the particle size of the first inorganic insulating particles 3a is minute as described above, as will be described later, it is possible to bond the first inorganic insulating particles 3a to each other at a low temperature, and to easily form the inorganic insulating layer 3 on the resin sheet 2. In addition, since the particle size of the first inorganic insulating particles 3a is minute, as will be described later, it is possible to bond the first inorganic insulating particles 3a to the second inorganic insulating particles 3b at a low temperature, and to adhere the second inorganic insulating particles 3b to each other at a low temperature.

As shown in FIG. 2(b), the first inorganic insulating particles 3a are bonded to each other via a neck structure 3a1. The first inorganic insulating particles 3a which are bonded to each other as described above form a three-dimensional net-like structure, and first voids V1 are disposed between the first inorganic insulating particles 3a. The first voids V1 are open pores having an opening of the inorganic insulating layer 3 on the first resin layer 4a side.

In a cross section along the thickness direction of the inorganic insulating layer 3, the first voids V1 are disposed to have a similar size as the first inorganic insulating particles 3a, and it is desirable that an area of the first voids V1 of the cross section is set to be not greater than twice the area of the first inorganic insulating particles 3a of the cross section, for example. In addition, it is desirable that a height of the first voids V1 in the thickness direction of the inorganic insulating layer 3 of the cross section is set to be not less than 3 nm and not greater than 110 nm, and it is desirable that a width of the first voids V1 in the planar direction of the inorganic insulating layer 3 of the cross section is set to be not less than 3 nm and not greater than 110 nm.

In addition, the particle size of the second inorganic insulating particles 3b is set to be not less than 0.5 μm and not greater than 5 μm. The particle size of the second inorganic insulating particles 3b is larger than that of the first inorganic insulating particles 3a as described above. Accordingly, when a crack expands to the second inorganic insulating particles 3b in a case of generation of a crack in the inorganic insulating layer 3, since the crack expands so as to by-pass along the surfaces of the second inorganic insulating particles 3b having a large particle size, it is possible to reduce the expansion of the crack, as significant energy is necessary for the expansion of the crack. In addition, since the second inorganic insulating particles 3b having a large particle size are adhered to each other via the first inorganic insulating particles 3a, it is possible to easily form second voids V2 which will be described later. In addition, since the particle size of the second inorganic insulating particles 3b is set to be not greater than 5 μm, it is possible to increase a contact area per unit volume of the first inorganic insulating particles 3a and the second inorganic insulating particles 3b to improve adhesion strength.

In addition, the particle sizes of the first inorganic insulating particles 3a and the second inorganic insulating particles 3b are measured by observing the cross section of the inorganic insulating layer 3 with a field-emission electronic microscope, imaging the cross section enlarged to include not less than 20 particles and not greater than 50 particles, and measuring the maximum size of each particle on the enlarged cross section.

It is desirable that the first inorganic insulating particles 3a described above are in a spherical shape. As a result, it is possible to increase a filling density of the first inorganic insulating particles 3a, to more strongly bond the first inorganic insulating particles 3a to each other, and to improve rigidity of the inorganic insulating layer 3. In addition, it is desirable that the second inorganic insulating particles 3b are in a spherical shape. As a result, it is possible to disperse stress of the surface of the second inorganic insulating particles 3b and to reduce the generation of the crack of the inorganic insulating layer 3 that originates from the surface of the second inorganic insulating particles 3b.

In addition, it is desirable that the first inorganic insulating particles 3a and the second inorganic insulating particles 3b are formed of the same material. As a result, in the inorganic insulating layer 3, it is possible to strongly bond the first inorganic insulating particles 3a and the second inorganic insulating particles 3b to each other, and to reduce the crack caused due to a difference of material properties.

In addition, it is desirable that hardness of the second inorganic insulating particles 3b is higher than that of first inorganic insulating particles 3a. As a result, it is possible to further reduce the expansion of the crack with the hard second inorganic insulating particles 3b.

Meanwhile, in the inorganic insulating layer 3, the second voids V2 along a planar direction, at least a part of which is surrounded by the first inorganic insulating particles 3a and the second inorganic insulating particles 3b, are disposed, and the first inorganic insulating particles 3a and the second inorganic insulating particles 3b form a three-dimensional net-like structure. The second voids V2 are open pores having an opening O on a main surface of the inorganic insulating layer 3 on the first resin layer 4a side. In addition, in a cross section along the thickness direction (Z direction), at least a part of the second voids V2 is surrounded by the inorganic insulating layer 3.

In the cross section along the thickness direction of the inorganic insulating layer 3, the second voids V2 are formed to have a similar size as the second inorganic insulating particles 3b, and it is desirable that an area of the second voids V2 of the cross section is set to be not less than 0.5 times as much as that of the second inorganic insulating particles 3b of the cross section, for example. In addition, it is desirable that a height of the second voids V2 in the thickness direction of the inorganic insulating layer 3 of the cross section is set to be not less than 0.3 μm and not greater than 5 μm, and it is desirable that a width of the second voids V2 in the planar direction of the inorganic insulating layer 3 of the cross section is set to be not less than 0.3 μm and not greater than 5 μm.

In addition, in the cross section along the thickness direction of the inorganic insulating layer 3, the second voids V2 are formed to be larger than the first voids V1. The area of the second voids V2 of the cross section along the thickness direction of the inorganic insulating layer 3 is set to be not less than 0.005 times and not greater than 0.1 times as much as the area of the first voids V1, for example.

In addition, it is desirable that the volume of the second voids V2 is set to be not less than 8% and not greater less than 40% of the volume of the inorganic insulating layer 3. As a result, since the volume of the second voids V2 is not greater than 40% of the volume of the inorganic insulating layer 3, it is possible to improve adhesion strength of the first inorganic insulating particles 3a and the second inorganic insulating particles 3b, and to obtain high rigidity and a low coefficient of thermal expansion of the inorganic insulating layer 3. In addition, since the volume of the second voids V2 is not less than 8% of the volume of the inorganic insulating layer 3, it is possible to set many second voids V2 as open pores as will be described later.

Herein, a ratio of the volume of the second voids V2 to the volume of the inorganic insulating layer 3 is measured by considering an average value of an area rate of the second voids V2 to the cross section of the inorganic insulating layer 3 as the ratio thereof.

In addition, the inorganic insulating layer 3 includes protrusion portions 3p which are protruded towards the second resin layer 4b and are formed of the second inorganic insulating particles 3b. As a result, it is possible to form the large protrusion portions 3p and to improve adhesion strength of the inorganic insulating layer 3 and the second resin layer 4b with an anchor effect.

The first resin layer 4a adheres the inorganic insulating layer 3 to the wiring board when manufacturing the wiring board, and remains on the wiring board. For example, the first resin layer 4a includes a first resin 5a and a first inorganic insulating filler 6a coated with the first resin 5a.

In addition, a thickness of the first resin layer 4a is set to be not less than 3 μm and not greater than 30 μm, for example, and/or is set to be not less than 10% and not greater than 80% of the thickness of the resin sheet 2, for example. In addition, a Young's modulus of the first resin layer 4a is set to be not less than 0.2 GPa and not greater than 20 GPa, for example, and/or is set to be not less than 1% and not greater than 60% of the Young's modulus of the inorganic insulating layer 3, for example. Further, coefficients of the thermal expansion of the first resin layer 4a in the planar direction and the thickness direction are set to be not less than 20 ppm/° C. and not greater than 50 ppm/° C., for example. Moreover, a coefficient of thermal expansion of the first resin layer 4a in the planar direction is set to be not less than 200% and not greater than 1000% of the coefficient of thermal expansion of the inorganic insulating layer 3 in the planar direction, for example. In addition, a dielectric loss tangent of the first resin layer 4a is set to be not less than 0.005 and not greater than 0.02, for example. The Young's modulus, the coefficient of thermal expansion and the dielectric loss tangent of the first resin layer 4a are measured in the same manner as the inorganic insulating layer 3 described above, in a state where the first resin 5a is cured.

In addition, it is desirable that the thickness of the first resin layer 4a is smaller than that of the resin sheet 2. As a result, it is possible to improve flatness of the resin sheet 2 by increasing the thickness of the resin sheet 2 and to reduce a coefficient of thermal expansion of the wiring board by decreasing the thickness of the first resin layer 4a.

The first resin 5a is a main part of the first resin layer 4a and functions as an adhesive member. The first resin 5a is formed of a thermosetting resin such as an epoxy resin, a bismaleimide-triazine resin, a cyanate resin, a polyphenylene ether resin, a wholly aromatic polyamide resin or a polyimide resin, for example. This thermosetting resin is uncured or semi-cured in the insulating sheet 1. In addition, the uncured thermosetting resin is a thermosetting resin in A-stage based on ISO 472:1999, and the semi-cured thermosetting resin is a thermosetting resin in B-stage based on ISO 472:1999.

In addition, a Young's modulus of the first resin 5a is set to be not less than 0.1 GPa and not greater than 5 GPa, for example, and coefficients of thermal expansion of the first resin 5a in the planar direction and the thickness direction are set to be not less than 20 ppm/° C. and not greater than 50 ppm/° C., for example. In addition, the Young's modulus and the coefficient of thermal expansion of the first resin 5a are measured in the same manner as the inorganic insulating layer 3 described above, in a state where the first resin 5a is cured.

The first inorganic insulating filler 6a causes the first resin layer 4a to have a low coefficient of thermal expansion and high rigidity. The first inorganic insulating filler 6a is configured of a plurality particles which are formed of an inorganic insulating material such as silicon oxide, aluminum oxide, aluminum nitride, aluminum hydroxide, calcium carbonate, or the like, and it is desirable to use silicon oxide as an inorganic insulating material.

In addition, a Young's modulus of the first inorganic insulating filler 6a is set to be not less than 20 GPa and not greater than 100 GPa, for example, coefficients of thermal expansion of the first inorganic insulating filler 6a in the planar direction and the thickness direction are set to be not less than 0 ppm/° C. and not greater than 15 ppm/° C., for example, a particle size of particles of the first inorganic insulating filler 6a is set to be not less than 0.5 μm and not greater than 5.0 μm, for example, and a content of the first inorganic insulating filler 6a of the first resin layer 4a is set to be not less than 3% by volume and not greater than 60% by volume, for example. The Young's modulus and the coefficient of thermal expansion of the first inorganic insulating filler 6a are measured in the same manner as the inorganic insulating layer 3 described above. In addition, the particle size of the first inorganic insulating filler 6a is measured in the same manner as the first inorganic insulating particles 3a and the second inorganic insulating particles 3b. Further, the content of the first inorganic insulating filler 6a of the first resin layer 4a is measured by considering an average value of area rate of the first inorganic insulating filler 6a to the cross section of the first resin layer 4a as the content thereof.

Herein, the insulating sheet 1 includes a resin portion 7 which is formed by filling the second voids V2 with a part of the first resin layer 4a through the opening O. Since a Young's modulus of the resin portion 7 is lower than that of the inorganic insulating layer 3 as the resin portion 7 is formed of a resin material, when stress is applied to the inorganic insulating layer 3, it is possible to alleviate the stress due to the resin portion 7 and to reduce the generation of the crack of the inorganic insulating layer 3. In addition, since at least a part of the second voids V2 is disposed along the planar direction, it is possible to reduce the expansion of the crack along the thickness direction of the inorganic insulating layer 3 due to the resin portion 7 arranged in the second voids V2. Further, a part of the first resin layer 4a is filled in the second voids V2 through the opening O, it is possible to improve adhesion strength of the first resin layer 4a and the inorganic insulating layer 3 with an anchor effect.

The resin layer 7 includes a first resin 5a in the same manner as the first resin layer 4a. In addition, it is desirable that the resin portion 7 does not include the first inorganic insulating filler 6a, and in a case where the resin portion 7 includes the first inorganic insulating filler 6a, it is desirable that the content of the first inorganic insulating filler 6a of the resin portion 7 is set to be lower than the content of the first inorganic insulating filler 6a of the first resin layer 4a. As a result, it is possible that the first resin layer 4a obtains a low coefficient of thermal expansion and high rigidity and a Young's modulus of the resin portion 7 is reduced to further alleviate the stress applied to the inorganic insulating layer 3. In this case, the content of the first inorganic insulating filler 6a of the resin portion 7 is set to be not less than 0.05% and not greater than 30% of the content of the first inorganic insulating filler 6a of the first resin layer 4a, for example. In addition, the Young's modulus of the resin portion 7 is set to be not less than 0.1 GPa and not greater than 5 GPa, for example, and coefficients of thermal expansion of the resin portion 7 in the planar direction and the thickness direction are set to be not less than 20 ppm/° C. and not greater than 70 ppm/° C., for example. Further, the Young's modulus, the coefficient of thermal expansion, and the dielectric loss tangent of the resin portion 7 are measured in the same manner as the inorganic insulating layer 3 described above, in a state where the first resin 5a is cured.

In addition, it is desirable that the resin portion 7 is closely attached to the inorganic insulating layer 3 which surrounds the second voids V2. As a result, it is possible to improve adhesion strength of the inorganic insulating layer 3 and the resin portion 7.

It is desirable that the resin portion 7 is also filled in the first voids V1 in the same manner as the second voids V2.

Meanwhile, the second resin layer 4b remains in the wiring board with the inorganic insulating layer 3, and becomes a base for forming a conductive layer in the wiring board. The second resin layer 4b includes a second resin 5b and a second inorganic insulating filler 6b coated with the second resin 5b, for example.

In addition, a thickness of the second resin layer 4b is set to be not less than 0.1 μm and not greater than 5 μm, for example, and/or is set to be not less than 1% and not greater than 50% of the thickness of the resin sheet 2, for example, and/or is set to be not less than 1% and not greater than 50% of the thickness of the inorganic insulating layer 3, for example, and set to be not less than 1% and not greater than 15% of the thickness of the first resin layer 4a, for example. Further, a Young's modulus of the second resin layer 4b is set to be not less than 0.05 GPa and not greater than 5 GPa, for example, and/or is set to be not less than 0.05% and not greater than 10% of the Young's modulus of the inorganic insulating layer 3, for example, and/or is set to be not less than 5% and not greater than 75% of the Young's modulus of the first resin layer 4a, for example. Coefficients of thermal expansion of the second resin layer 4b in the planar direction and the thickness direction are set to be not less than 20 ppm/° C. and not greater than 100 ppm/° C., for example. In addition, the coefficient of thermal expansion of the second resin layer 4b in the planar direction is set to be not less than 5% and not greater than 50% of the coefficient of thermal expansion of the resin sheet 2 in the planar direction, for example, and/or is set to be not less than twice and not greater than 10 times as much as the coefficient of thermal expansion of the inorganic insulating layer 3 in the planar direction, for example. A dielectric loss tangent of the second resin layer 4b is set to be not less than 0.005 and not greater than 0.02, for example. In addition, the Young's modulus, the coefficient of thermal expansion, and the dielectric loss tangent of the second resin layer 4b are measured in the same manner as the inorganic insulating layer 3 described above, in a state where the second resin 5b is cured.

The second resin 5b is a main part of the second resin layer 4b, and becomes a base of a conductive layer. The second resin 5b is formed of a thermosetting resin such as an epoxy resin, a bismaleimide-triazine resin, a cyanate resin or a polyimide resin. In the insulating sheet 1, the thermosetting resin may be semi-cured or may be cured, however, is desirable to be semi-cured from a viewpoint of adhesion strength with the inorganic insulating layer 3. In addition, the cured thermosetting resin is a thermosetting resin in C-stage based on ISO 472:1999.

In addition, a Young's modulus of the second resin 5b is set to be not less than 0.05 GPa and not greater than 5 GPa, for example, and coefficients of thermal expansion of the second resin 5b in the planar direction and the thickness direction are set to be not less than 20 ppm/° C. and not greater than 100 ppm/° C., for example. Further, the Young's modulus and the coefficient of thermal expansion of the second resin 5b are measured in the same manner as the inorganic insulating layer 3 described above, in a state where the second resin 5b is cured.

The second inorganic insulating filler 6b includes a function of improving flame retardance of the second resin layer 4b, and a function of reducing viscosity and improving workability when handling the insulating sheet 1. The second inorganic insulating filler 6b is formed of an inorganic insulating material such as silicon oxide, for example.

In addition, a Young's modulus of the second inorganic insulating filler 6b is set to be not less than 20 GPa and not greater than 100 GPa, for example. In addition, coefficients of thermal expansion of the second inorganic insulating filler 6b in the planar direction and the thickness direction are set to be not less than 0 ppm/° C. and not greater than 15 ppm/° C., for example. A particle size of the second inorganic insulating filler 6b is set to be not less than 0.05 μm and not greater than 0.7 μm, for example, and/or is set to be not less than 5% and not greater than 50% of the first inorganic insulating filler 6a, for example. A content of the second inorganic insulating filler 6b of the second resin layer 4b is set to be not less than 0% by volume and not greater than 10% by volume, for example. In addition, a ratio of the content of the second inorganic insulating filler 6b of second resin layer 4b to the content of the first inorganic insulating filler 6a of the first resin layer 4a is set to be not less than 2% and not greater than 50%, for example. The Young's modulus, the coefficient of thermal expansion, the particle size, and the content of the second inorganic insulating filler 6b are measured in the same manner as the first inorganic insulating filler 6a.

In the insulating sheet 1 of the embodiment described above, the inorganic insulating layer 3 is disposed on the resin sheet 2, and includes the first inorganic insulating particles which have a particle size of not less than 3 nm and not greater than 110 nm and are bonded to each other. Accordingly, as will be described later, since it is possible to form the inorganic insulating layer 3 with high flatness, a wiring board is manufactured using the insulating sheet 1 and the inorganic insulating layer 3 is made to remain in the wiring board, and thus, it is possible to obtain a fine conductive layer which is to be disposed on the inorganic insulating layer 3, and to improve wiring density of the wiring board.

(Mounting Structure)

Next, a mounting structure including a wiring board manufactured using the insulating sheet 1 described above will be described in detail with reference to the drawings.

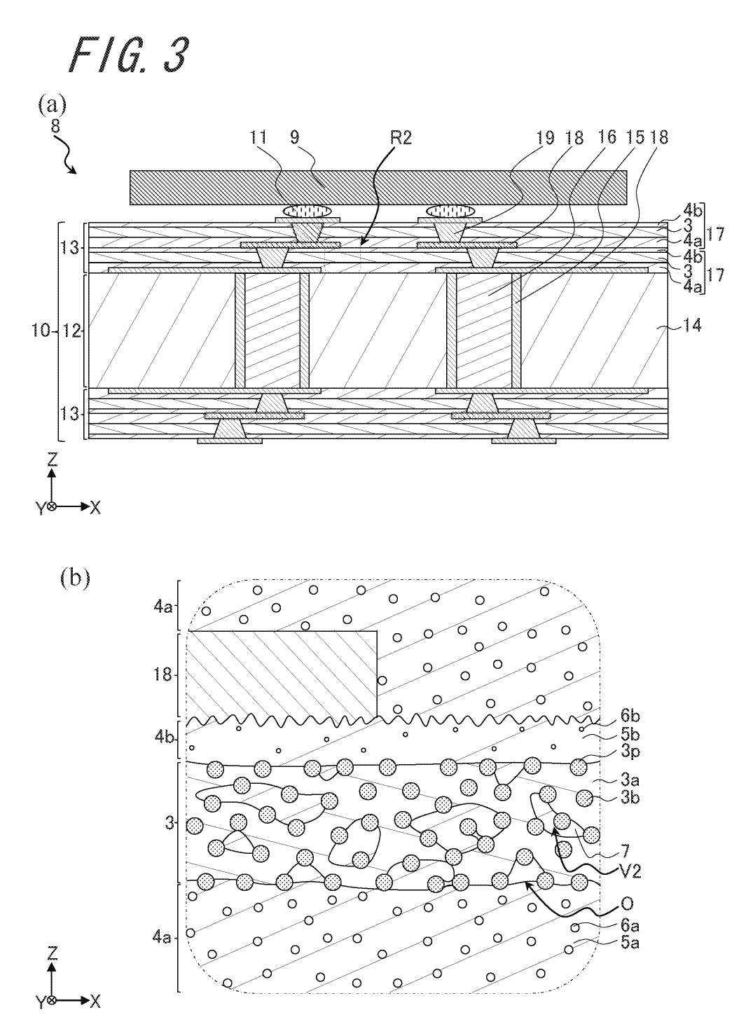

A mounting structure 8 shown in FIG. 3(a) is used for electronic devices such as various audio visual devices, household electrical appliances, communication devices, a computer and peripheral devices thereof, for example. The mounting structure 8 includes an electronic component 9, and a wiring board 10 on which the electronic component 9 is mounted.

The electronic component 9 is a semiconductor device such as an IC or an LSI, for example, and is flip-chip-mounted on the wiring board 10 via a conductive bump 11 which is formed of solder or the like. A base material of the electronic component 9 is formed of a semiconductor material such as silicon, germanium, gallium arsenide, gallium arsenide phosphide, gallium nitride or silicon carbide. In addition, a thickness of the electronic component 9 is set to be not less than 0.1 mm and not greater than 1 mm, for example, and a coefficient of thermal expansion of the electronic component 9 in the planar direction is set to be not less than 2 ppm/° C. and not greater than 5 ppm/° C.

In the embodiment, the wiring board 10 is a build-up multilayer wiring board, and includes a core board 12 and a pair of wiring layers 13 which are disposed on the top and bottom of the core board 12. In addition, a thickness of the wiring board 10 is set to be 0.2 mm to 1.2 mm, for example.

The core board 12 realizes an improvement in the rigidity of the wiring board 10 and electrically connects the pair of wiring layers 13. The core board 12 includes a resin matrix 14 in which through holes are formed along the thickness direction, tubular through-hole conductors 15 which are adhered to an inner wall of the through holes, and columnar insulators 16 which are arranged in regions surrounded by the through-hole conductors 15.

The resin matrix 14 improves rigidity of the core board 12. The resin matrix 14 includes a resin, a base material coated with the resin, and an inorganic insulating filler coated with the resin, for example. In addition, a thickness of the resin matrix 14 is set to be not less than 0.1 mm and not greater than 1.2 mm, for example, a Young's modulus of the resin matrix 14 is set to be not less than 0.2 GPa and not greater than 10 GPa, for example, a coefficient of the resin matrix 14 in the planar direction is set to be not less than 3 ppm/° C. and not greater than 20 ppm/° C., for example, a coefficient of thermal expansion of the resin matrix 14 to the thickness direction is set to be not less than 15 ppm/° C. and not greater than 50 ppm/° C., for example, and a dielectric loss tangent of the resin matrix 14 is set to be not less than 0.005 and not greater than 0.02, for example. The Young's modulus, the coefficient of thermal expansion, and the dielectric loss tangent of the resin matrix 14 are measured in the same manner as the inorganic insulating layer 3 described above, in a state where the resins are cured.

The resin included in the resin matrix 14 is a main part of the resin matrix 14. The resin is formed of a resin material such as an epoxy resin, a bismaleimide triazine resin, a cyanate resin, a polyparaphenylene benzobisoxazole resin, a wholly aromatic polyamide resin, a polyimide resin, an aromatic liquid crystal polyester resin, a polyether ether ketone resin or a polyether ketone resin or the like. In addition, a Young's modulus of the resin of the resin matrix 14 is set to be not less than 0.1 GPa and not greater than 5 GPa, for example, and coefficients of thermal expansion of the resin of the resin matrix 14 in the planar direction and the thickness direction are set to be not less than 20 ppm/° C. and not greater than 50 ppm/° C., for example. The Young's modulus, the coefficient of thermal expansion and the dielectric loss tangent of the resin matrix 14 are measured in the same manner as the inorganic insulating layer 3 described above, in a state where the resins are cured.

The base material included in the resin matrix 14 realizes high rigidity and low coefficient of thermal expansion of the resin matrix 14. The base material is formed of woven fabric configured by fibers, non-woven fabric, or material obtained by arranging fiber in one direction. In addition, the fiber is formed of glass fiber, resin fiber, carbon fiber, metal fiber, or the like, for example.

The inorganic insulating filler included in the resin matrix 14 realizes high rigidity and low coefficient of thermal expansion of the resin matrix 14. The inorganic insulating filler is configured of a plurality of particles which are formed of inorganic insulating materials such as silicon oxide, aluminum oxide, aluminum nitride, aluminum hydroxide or calcium carbonate, for example. In addition, a Young's modulus of the inorganic insulating filler of the resin matrix 14 is set to be not less than 20 GPa and not greater than 100 GPa, for example, coefficients of thermal expansion of the inorganic insulating filler of the resin matrix 14 in the planar direction and the thickness direction are set to be not less than 0 ppm/° C. and not greater than 15 ppm/° C., for example, a particle size of the inorganic insulating filler of the resin matrix 14 is set to be not less than 0.5 μm and not greater than 5.0 μm, for example, and a content of the inorganic insulating filler of the resin matrix 14 is set to be not less than 3% by volume and not greater than 60% by volume, for example. The Young's modulus, the coefficient of thermal expansion, the particle size, and the content of the inorganic insulating filler of the resin matrix 14 are measured in the same manner as the first inorganic insulating filler 6a described above.

The through-hole conductors 15 electrically connect the wiring layers 13 on the top and bottom of the core board 12. The through-hole conductors 15 are formed of a conductive material such as a copper, silver, gold, aluminum, nickel, or chrome, for example. In addition, coefficients of thermal expansion of the through-hole conductors 15 in the planar direction and the thickness direction are set to be not less than 14 ppm/° C. and not greater than 18 ppm/° C., for example.

The insulators 16 form support surfaces of via-conductors 19 which will be described later. The insulators 16 are formed of a resin material such as a polyimide resin, an acrylic resin, an epoxy resin, a cyanate resin, a fluorine resin, a silicon resin, a polyphenylene ether resin or a bismaleimide triazine resin, for example.

Meanwhile, as described above, the pair of wiring layers 13 are disposed on the top and bottom of the core board 12. Each wiring layer 13 includes insulating layers 17 in which via-holes are formed along the thickness direction, conductive layers 18 which are partially disposed on the resin matrix 14 or the insulating layers 17, and via-conductors 19 which are disposed in the via-holes.

The insulating layer 17 includes the first resin layer 4a, the inorganic insulating layer 3 disposed on the first resin layer 4a, and the second resin layer 4b disposed on the inorganic insulating layer 3.

The first resin layer 4a adheres the resin matrix 14 and the insulating layer 17 or adheres the laminated insulating layers 17, while being adhered to the side surface and the upper surface of the conductive layers 18, and is arranged between the conductive layers 18 disposed apart from each other along the planar direction from each other to function as a support member. The first resin layer 4a is a layer which is included in the insulating sheet 1 described above. The thermosetting resin of the first resin layer 4a is cured in the wiring board 10.

Since the first resin layer 4a comes in contact with the side surface and the upper surface of the conductive layers 18, it is desirable that the first resin layer 4a has a lower dielectric loss tangent than the second resin layer 4b which only comes in contact with the lower surface of the conductive layers 18. As a result, it is possible to improve a signal transmission property of the conductive layers 18.

The inorganic insulating layer 3 is a main part of the insulating layer 17, comes in contact with only the lower surface of the conductive layers 18 to function as the support member, and functions as the support member of the conductive layers 18 which are disposed apart from each other along the thickness direction.

The inorganic insulating layer 3 is a layer which is included in the insulating sheet 1 described above, and is formed of an inorganic insulating material which has a lower coefficient of thermal expansion, higher rigidity, a lower dielectric loss tangent, and a higher insulating property compared to the resin material. Accordingly, by reducing a coefficient of thermal expansion of the insulating layer 17 in the planar direction, it is possible to reduce a difference in coefficients of thermal expansion between the wiring board 10 and the electronic component 9 in the planar direction, and to reduce a warp of the wiring board 10. In addition, by reducing the coefficient of thermal expansion of the insulating layer 17 in the thickness direction, it is possible to reduce a difference in coefficients of thermal expansion between the insulating layer 17 and the via-conductor 19, and to reduce disconnection of the via-conductor 19. By improving the rigidity of the insulating layer 17, it is possible to improve the rigidity of the wiring board 10 without increasing the thickness thereof. By reducing the dielectric loss tangent of the insulating layer 17, it is possible to improve a signal transmission property of the conductive layer 18 disposed on the insulating layer 17. By improving the insulating property of the insulating layer 17, it is possible to reduce short circuits between the conductive layers 18 arranged on the top and bottom of the insulating layer 17.

The second resin layer 4b is interposed between the inorganic insulating layer 3 and the conductive layer 18 to function as an adhesive member. The second resin layer 4b is a layer which is included in the insulating sheet 1 described above, and since it is more difficult for the crack to be expanded in the second resin layer 4b than the inorganic insulating layer 3 formed of an inorganic insulating material, it is possible to suppress the crack generated in the inorganic insulating layer 3 from reaching the conductive layer 18, and to reduce disconnection of the conductive layer 18.

Herein, it is desirable that the second resin layer 4b has a smaller thickness and a lower Young's modulus than the first resin layer 4a, the inorganic insulating layer 3, and the conductive layer 18.

As a result, with a deformation of the second resin layer 4b which is thin and is easy to perform elastic deformation, since it is possible to alleviate the stress caused due to the difference in coefficient of thermal expansion between the inorganic insulating layer 3 and the conductive layer 18, it is possible to reduce separation of the inorganic insulating layer 3 and the conductive layer 18, and to reduce disconnection of the conductive layer 18. By reducing the thickness of the second resin layer 4b which has a low Young's modulus, it is possible to suppress the reduction of rigidity of the wiring board 10. By reducing the thickness of the second resin layer 4b which has a high coefficient of thermal expansion, it is possible to suppress an increase of a coefficient of thermal expansion of the wiring board 10. By reducing the thickness of the second resin layer 4b which has a high dielectric loss tangent, it is possible to improve a signal transmission property of the conductive layer 18 by bringing the inorganic insulating layer 3 which has a low dielectric loss tangent and the conductive layer 18 closer to each other. In addition, by reducing the Young's modulus of the second resin layer 4b, it is possible to improve adhesion strength of the inorganic insulating layer 3 and the conductive layer 18.

Since the second resin layer 4b can be provided as long as it is interposed between the inorganic insulating layer 3 and the conductive layer 18, there is less demand for an increase of the thickness thereof and the thickness can be easily reduced, compared to the first resin layer 4a which is interposed between the conductive layers 18 which are disposed apart from each other in the planar direction.

Since the thickness of the first resin layer 4a is larger than that of the second resin layer 4b, it is desirable that the coefficient of thermal expansion thereof is lower than that of the second resin layer 4b. As a result, it is possible to reduce the coefficient of thermal expansion of the wiring board 10.

It is desirable that a material having a lower Young's modulus, a higher coefficient of thermal expansion, and higher dielectric loss tangent, compared to the resin material included in the first resin layer 4a is used as the resin material included in the second resin layer 4b. As a result, it is possible that the second resin layer 4b has a low Young's modulus, and the first resin layer 4a has a low coefficient of thermal expansion and a low dielectric loss tangent. As a combination of the resin materials described above, it is possible to use an epoxy resin for the second resin layer 4b, and a polyphenylene ether resin, a polyphenylene oxide resin, or a fluorine resin for the first resin layer 4a.

As shown in FIG. 3(b), it is desirable that a particle size of the second inorganic insulating filler 6b is smaller than the particle size of the first inorganic insulating filler 6a. As a result, it is possible that the second resin layer 4b has a low Young's modulus, and the first resin layer 4a has a low coefficient of thermal expansion or a low dielectric loss tangent.

In addition, it is desirable that the content of the second inorganic insulating filler 6b of the second resin layer 4b is smaller than the content of the first inorganic insulating filler 6a of the first resin layer 4a. As a result, it is possible that the second resin layer 4b has a low Young's modulus, and the first resin layer 4a has a low coefficient of thermal expansion or a low dielectric loss tangent.

In addition, it is desirable that minute concavity and convexity are disposed on the main surface of the second resin layer 4b which comes in contact with the conductive layers 18. As a result, it is possible to improve adhesion strength of the second resin layer 4b and the conductive layer 18. In addition, as described above, concavity and convexity are disposed on the main surface of the second resin layer 4b which comes in contact with the inorganic insulating layer 3 by burying the protrusion portion 3p of the inorganic insulating layer 3. Further, it is desirable that the concavity and convexity on the main surface of the second resin layer 4b which comes in contact with the inorganic insulating layer 3 are disposed to be minuter than the concavity and convexity on the main surface which comes in contact with the conductive layer 18.

An arithmetic mean roughness of the main surface of the second resin layer 4b which comes in contact with the conductive layer 18 is set to be not less than 0.3 μm and not greater than 2 μm, for example, and an arithmetic mean roughness of the main surface of the second resin layer 4b which comes in contact with the inorganic insulating layer 3 is set to be not less than 0.3 μm and not greater than 5 μm, for example. In addition, the arithmetic mean roughness of the main surface of the second resin layer 4b which comes in contact with the inorganic insulating layer 3 is set to be not less than 1.2 times and not greater than 2.5 times as much as that of the main surface which comes in contact with the conductive layer 18, for example. The arithmetic mean roughness is measured based on ISO 4287:1997.

The conductive layers 18 are disposed apart from each other along the planar direction and the thickness direction, and function as wiring for grounding, wiring for power supply, or wiring for signals. The conductive layers 18 are formed of a conductive material, such as copper, silver, gold, aluminum, nickel or chrome, for example. In addition, a thickness of the conductive layer 18 is set to be not less than 3 μm and not greater than 20 μm, and a coefficient of thermal expansion thereof is set to be not less than 14 ppm/° C. and not greater than 18 ppm/° C., for example.

The via-conductors 19 electrically connect the conductive layers 18 which are disposed apart from each other in the thickness direction, and are formed in a columnar shape to have a narrower width towards the core board 12. The via-conductors 19 are formed of a conductive material such as copper, silver, gold, aluminum, nickel or chrome, for example. In addition, a coefficient of thermal expansion of the via-conductors 19 is set to be not less than 14 ppm/° C. and not greater than 18 ppm/° C., for example.

Accordingly, the mounting structure 8 described above exhibits desired functions by driving or controlling the electronic component 9 based on power and signals supplied via the wiring board 10.

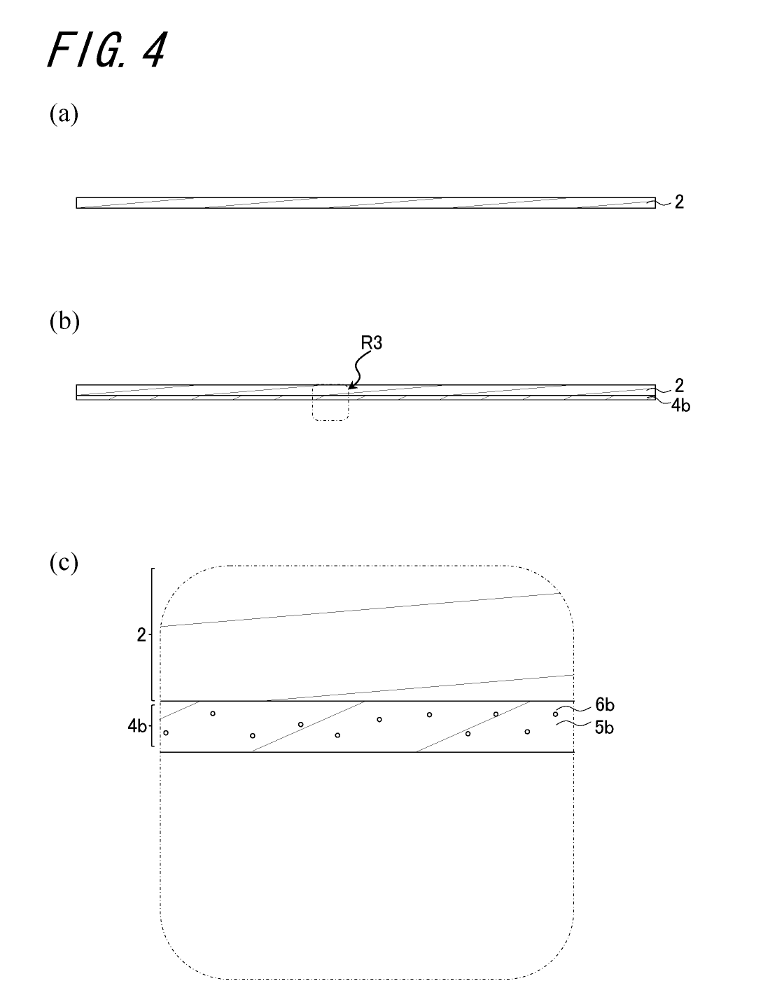

Next, a method of manufacturing the mounting structure 8 including the wiring board 10 manufactured using the insulating sheet 1 will be described with reference to FIGS. 4 to 11. First, a method of manufacturing the insulating sheet 1 will be described in detail.

(Manufacture of Insulating Sheet)

As described in FIG. 4, the second resin layer 4b is formed on the resin sheet 2. In detail, this is performed as follows, for example.

First, as shown in FIG. 4(a), the resin sheet 2 is formed by extrusion molding, for example. Next, as shown in FIGS. 4(b) and 4(c), the second resin layer 4b is formed on the resin sheet 2 by applying a second varnish including a solvent, the second resin 5b and the second inorganic insulating filler 6b on the resin sheet 2 using a bar coater, a die coater or a curtain coater, for example, and drying the second varnish to evaporate the solvent. In addition, the second resin 5b is in A stage.

Herein, since the resin sheet 2 is formed by extrusion molding, for example, a resin sheet 2 having higher flatness is obtained compared to metal foil.

In addition, since the second resin layer 4b is formed by applying the second varnish having high fluidity onto the resin sheet 2 having high flatness, a second resin layer 4b having high flatness is obtained. Further, it is possible to easily form the second resin layer 4b which has a thin and even thickness, by forming the second resin layer 4b as described above.

In addition, after forming the second resin layer 4b on the resin sheet 2, it is desirable to proceed curing of the second resin layer 4b by heating the second resin layer 4b to a temperature of not lower than a curing start temperature of the second resin 5b included in the second resin layer 4b and lower than a melting point of the resin included in the resin sheet 2. As a result, in a step of (2) which will be described later, when applying inorganic insulating sol 3x on the second resin layer 4b, it is possible to reduce damage to the second resin layer 4b caused by a solvent included in the inorganic insulating sol. The thermosetting resin of the cured second resin layer 4b is in B stage or C stage, however, it is desirable to be in B stage from a viewpoint of adhesion strength to the inorganic insulating layer 3. Further, heating for proceeding the curing of the second resin layer 4b may be performed at the same time as the drying of the second resin layer 4b, or may be performed after the drying of the second resin layer 4b.

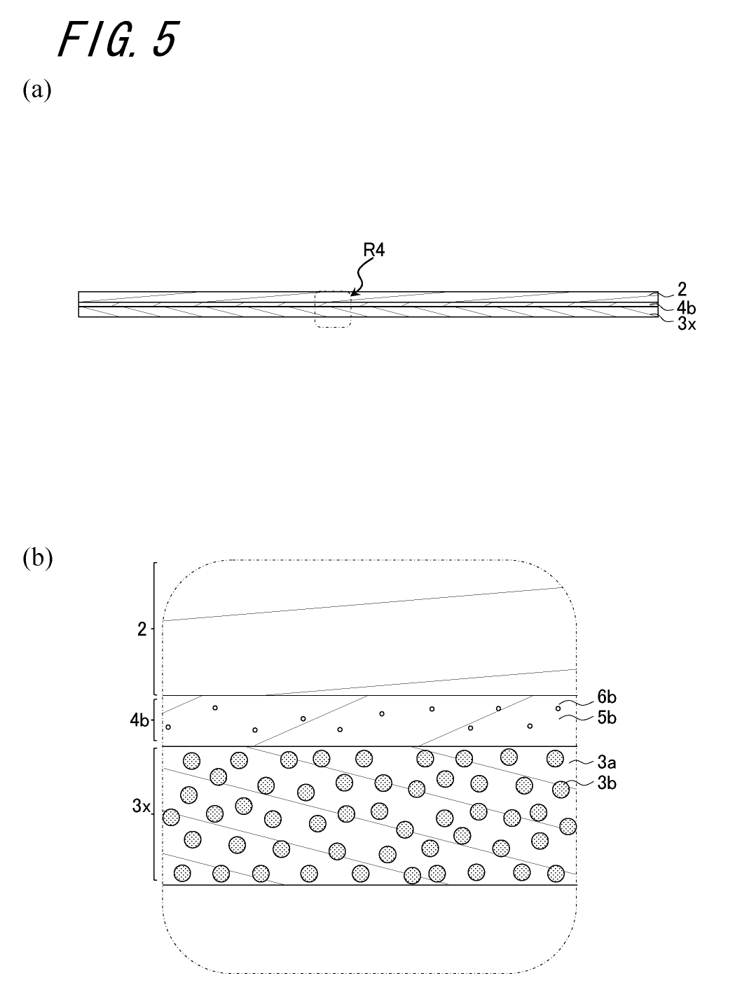

(2) As shown in FIG. 5, the inorganic insulating sol 3x is applied on the second resin layer 4b. In detail, this is performed as follows, for example.

First, the inorganic insulating sol 3x including a solid content formed of the first inorganic insulating particles 3a and the second inorganic insulating particles 3b and a solvent is prepared. Next, the inorganic insulating sol 3x is applied on the second resin layer 4b using a dispenser, a bar coater, a die coater or screen printing, for example.

As a result, since the inorganic insulating sol 3x is applied on the second resin layer 4b which is formed to have high flatness in the step of (1), it is possible to improve flatness of the inorganic insulating sol 3x which is provided on the second resin layer 4b.

The first inorganic insulating particles 3a having small particle size can be manufactured by purifying a silicate compound such as a sodium silicate solution (liquid glass) and chemically precipitating silicon oxide with a method of, for example, hydrolysis. In addition, by manufacturing the first inorganic insulating particles 3a as described above, it is possible to suppress crystallization of the first inorganic insulating particles 3a and to maintain an amorphous state. Further, when manufacturing the first inorganic insulating particles 3a as described above, the first inorganic insulating particles 3a may include an impurity such as sodium oxide of not less than 1 ppm and not greater than 5000 ppm.

Herein, it is desirable that the particle size of the first inorganic insulating particles 3a is set to be not less than 3 nm. As a result, it is possible to reduce viscosity of the inorganic insulating sol 3x and to improve flatness of the inorganic insulating layer 3.

The second inorganic insulating particles 3b having large particle size can be manufactured by purifying a silicate compound such as a sodium silicate solution (liquid glass), spraying a solution in which silicon oxide is chemically precipitated into a flame, and heating at a temperature of not lower than 800° C. and not higher than 1500° C. while suppressing formation of an aggregate. Herein, since the second inorganic insulating particles 3b are easily manufactured by heating at a high temperature while suppressing formation of an aggregate, compared to the first inorganic insulating particles 3a, by manufacturing the second insulating particles 3b at a high temperature, it is possible to more easily improve hardness of the second inorganic insulating particles 3b than that of the first inorganic insulating particles 3a.

Herein, it is desirable that heating time when manufacturing the second inorganic insulating particles 3b is set to be not shorter than 1 second and not longer than 180 seconds. As a result, by shortening the heating time, even in a case of heating at a temperature of not lower than 800° C. and not higher than 1500° C., it is possible to suppress crystallization of the second inorganic insulating particles 3b and to maintain an amorphous state.

A solvent included in the inorganic insulating sol 3x is formed of an organic solvent such as methanol, isopropanol, n-butanol, ethylene glycol, ethylene glycol mono-propyl ether, methyl ethyl ketone, methyl isobutyl ketone, xylene, propylene glycol monomethyl ether, propylene glycol monomethyl ether acetate or dimethylacetamide, and it is desirable to be formed of methanol, isopropanol or propylene glycol monomethyl ether among the above. As a result, it is possible to evenly apply the inorganic insulating sol 3x and to efficiently evaporate the solvent in a step of (3). In addition, the solvent may be obtained by mixing two or more types of the organic solvents described above.

It is desirable that the inorganic insulating sol 3x includes a solid content of not less than 10% by volume and not greater than 50% by volume and a solvent of not less than 50% by volume and not greater than 90% by volume. As a result, by including the solvent of not less than 50% by volume of the inorganic insulating sol 3x, it is possible to reduce viscosity of the inorganic insulating sol 3x, to improve flatness of the upper surface of the inorganic insulating layer 3, and to improve flatness of the upper surface of the wiring board 10. In addition, since an ingredient amount of the solid of the inorganic insulating sol 3x increases by including the solvent of not greater less than 90% by volume of the inorganic insulating sol 3x, it is possible to improve productivity of the inorganic insulating layer 3.

In the embodiment, the solid content of the inorganic insulating sol 3x includes the first inorganic insulating particles 3a of not less than 20% by volume and not greater than 40% by volume, and includes the second inorganic insulating particles 3b of not less than 60% by volume and not greater than 80% by volume.

(3) The inorganic insulating sol 3x is dried to evaporate the solvent included in the inorganic insulating sol 3x. As a result, the solid content of the inorganic insulating sol 3x remains on the second resin layer 4b.

Herein, since the inorganic insulating sol 3x includes the second inorganic insulating particles 3b having a large particle size of not less than 0.5 μm, when evaporating the solvent of the inorganic insulating sol 3x, the solvent evaporates more in a region including the first inorganic insulating particles 3a having a small particle size, compared to a region including the second inorganic insulating particles 3b having a large particle size. In addition, as the solid content of the inorganic insulating sol 3x includes the second inorganic insulating particles 3b of not less than 60% by volume, since lots of second inorganic insulating particles 3b are obtained and the second inorganic insulating particles 3b are close to each other since a stage before drying, the solvent locally evaporates a lot and contraction is generated in a region surrounded by the second inorganic insulating particles 3b, and then, the second voids V2 are formed. As a result, it is possible to form the second voids V2 surrounded by the first inorganic insulating particles 3a and the second inorganic insulating particles 3b.

In addition, since the solvent has excellent wettability with the second inorganic insulating particles 3b, the solvent easily remains at a neighboring point between the second inorganic insulating particles 3b. As a result, since the first inorganic insulating particles 3a move to the neighboring point with the movement of the solvent to the neighboring point, it is possible to form large second voids V2 in regions other than the neighboring point between the second inorganic insulating particles 3b. In addition, by forming the second voids V2 as described above, it is possible to form large second voids V2 obtained by bonding of second voids V2 to each other in the formation in the regions other than the neighboring point, and to easily form the second voids V2 which are open pores having an opening O. Further, by moving the first inorganic insulating particles 3a to the neighboring point, it is possible to interpose the first inorganic insulating particles 3a between the second inorganic insulating particles 3b.

In addition, at a boundary with the second resin layer 4b, since large amounts of solvent evaporate and the large contraction is performed in the region including the first inorganic insulating particles 3a, compared to the region including the second inorganic insulating particles 3b, the protrusion portion 3p which protrudes towards the second resin layer 4b is formed. In the step of (3), when heating for forming the inorganic insulating layer 3, the protrusion portion 3p is buried in the second resin layer 4b which is softened by the heating.

In addition, since the solid content of the inorganic insulating sol 3x includes the first inorganic insulating particles 3a of not less than 20% by volume, it is possible to improve rigidity of the inorganic insulating layer 3 by securing an amount of the first inorganic insulating particles 3a interposed on the neighboring point between the second inorganic insulating particles 3b and reducing a region in which the second inorganic insulating particles 3b come in contact with each other.

In addition, it is desirable that the drying of the inorganic insulating sol 3x is performed by heating and air-drying, for example, a temperature thereof is set to be not lower than 20° C. and lower than a boiling point of the solvent (when two or more types of solvents are mixed, a boiling point of a solvent having a lowest boiling point), and heating time is set to be not shorter than 20 seconds and not longer than 30 minutes. As a result, by reducing boiling of the solvent, it is possible to improve filling density of the second inorganic insulating particles 3b.

It is possible to form the second voids V2 in a desired shape, by suitably adjusting a particle size or a content of the first inorganic insulating particles 3a or the second inorganic insulating particles 3b, and a type, an amount, drying time, drying temperature, airflow or wind velocity when drying, or a heating temperature or heating time after the drying of the solvent of the inorganic insulating sol 3x.

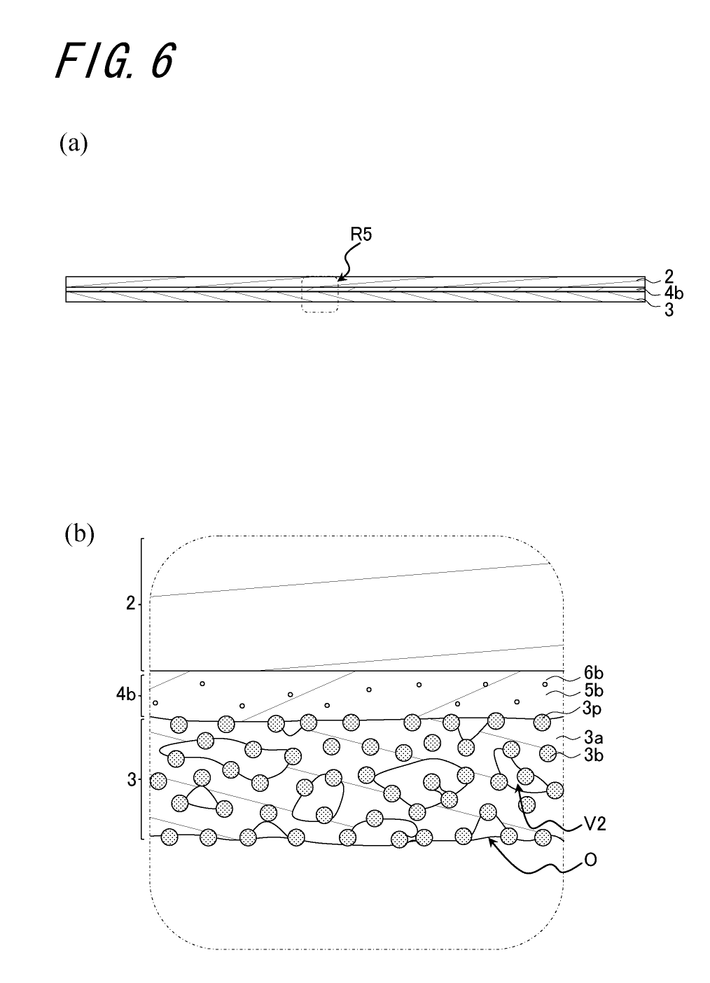

(4) As shown in FIG. 6, the inorganic insulating layer 3 is formed on the second resin layer 4b by heating the solid content of the inorganic insulating sol 3x. In detail, this is performed as follows, for example.

By heating the solid content of the inorganic insulating sol 3x at a temperature of lower than a melting point of resins included in the resin sheet 2, bonding the first inorganic insulating particles 3a to each other, and bonding the first inorganic insulating particles 3a to the second inorganic insulating particles 3b, the solid content of the inorganic insulating sol 3x becomes the inorganic insulating layer 3, and the inorganic insulating layer 3 is formed on the second resin layer 4b.

As a result, by heating the solid content of the inorganic insulating sol 3x which is formed to have high flatness in the step of (2), it is possible to obtain the inorganic insulating layer 3 having high flatness.

Herein, in the embodiment, since the particle size of the first inorganic insulating particles 3a is set to be not greater than 110 nm, even though it is heated at a low temperature of lower than the melting point of the resin sheet 2, it is possible to strongly bond the first inorganic insulating particles 3a to each other, to strongly bond the first inorganic insulating particles 3a to the second inorganic insulating particles 3b, and to adhere the second inorganic insulating particles 3b to each other via the first inorganic insulating particles 3a. For example, a melting point of a polyethylene terephthalate resin is about 260° C., and a temperature to strongly bond the particles of silicon oxide having a particle size of not greater than 110 nm to each other is about 100° C. to 180° C.

Since the particle size of the first inorganic insulating particles 3a is set to be an ultrafine size of not greater than 110 nm, and atoms of the first inorganic insulating particles 3a, particularly atoms on the surface move actively, it is assumed that the first inorganic insulating particles 3a are strongly bonded to each other and the first inorganic insulating particles 3a are strongly bonded to the second inorganic insulating particles 3b even at such a low temperature.

Accordingly, since it is possible to reduce deformation of the resin sheet 2 by heating the solid content of the inorganic insulating sol 3x at a temperature of lower than the melting point of the resin sheet 2, it is possible to form the inorganic insulating layer 3 on the resin sheet 2 without losing flatness of the resin sheet 2. In addition, since it is possible to form the inorganic insulating layer 3 at a low temperature as described above, it is possible to easily form the inorganic insulating layer 3 when compared to the case of forming the inorganic insulating layer 3 at a high temperature.

In addition, since the first inorganic insulating particles 3a are bonded to each other at a low temperature as described above, it is possible to bond the first inorganic insulating particles 3a to each other via the neck structure 3a1 and to properly form the first voids V1 as open pores.

Herein, by setting the particle size of the first inorganic insulating particles 3a to be smaller, it is possible to lower the temperature at which the first inorganic insulating particles 3a are strongly bonded to each other. For example, a temperature to strongly bond the particles of silicon oxide having a particle size of not greater than 50 nm to each other is about 50° C. to 120° C.

In addition, it is desirable that a heating temperature of the solid content of the inorganic insulating sol 3x is set to be not lower than the boiling point of the solvent. As a result, by setting the heating temperature to be not lower than the boiling point of the solvent, it is possible to efficiently evaporate the remaining solvent.

In addition, it is desirable that the heating temperature of the solid content of the inorganic insulating sol 3x is set to be not higher than a crystallization start temperature of the first inorganic insulating particles 3a and the second inorganic insulating particles 3b. As a result, by setting the heating temperature to be lower than the crystallization start temperature of the first inorganic insulating particles 3a and the second inorganic insulating particles 3b, since it is possible to suppress the crystallization of the first inorganic insulating particles 3a and the second inorganic insulating particles 3b and to improve a ratio of an amorphous state, it is possible to reduce cracks generated due to the phase transition associated with the crystallization. In addition, the crystallization start temperature is a temperature at which an amorphous inorganic insulating material starts to be crystallized, that is, a temperature at which a volume of crystalline phase region increases. Further, for example, the crystallization start temperature of silicon oxide is about 1300° C.

It is desirable that the heating temperature of the solid content of the inorganic insulating sol 3x is set to be lower than a pyrolysis start temperature of the second resin layer 4b. As a result, it is possible to suppress the reduction of a property of the second resin layer 4b. In addition, the pyrolysis start temperature is a temperature at which a mass of the resins decreases by 5%, in the thermogravimetry based on ISO 11358:1997.

The heating temperature of the inorganic insulating sol 3x is set to be not lower than 50° C. and lower than 180° C., for example, heating time is set to be not shorter than 0.05 hours and not longer than 24 hours, for example, and the heating thereof is performed in atmosphere, for example.

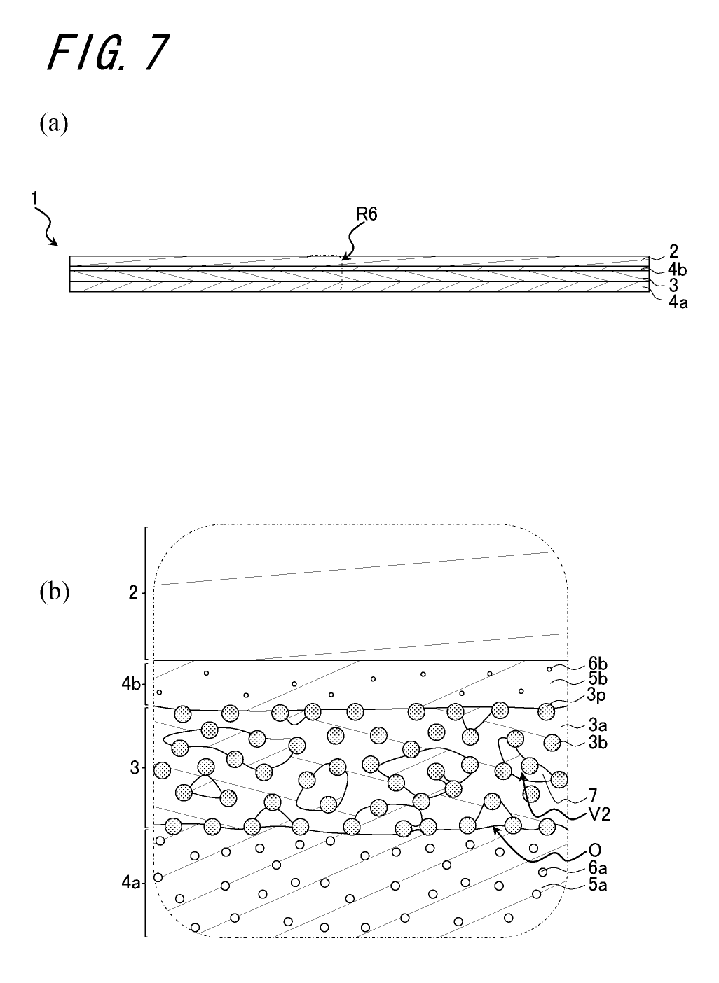

(5) As shown in FIG. 7, the insulating sheet 1 is manufactured by forming the first resin layer 4a formed of an uncured thermosetting resin on the inorganic insulating layer 3. In detail, this is performed as follows, for example.

First, a first varnish including a solvent, the first resin 5a, and the first inorganic insulating filler 6a is applied on the inorganic insulating layer 3. In addition, the thermosetting resin of the first resin 5a is in A stage. Next, the first resin layer 4a including the uncured first resin 5a is formed on the inorganic insulating layer 3, by drying the first varnish to evaporate the solvent.

Herein, the uncured state of the first resin 5a of the first resin layer 4a is maintained in the insulating sheet 1. As a result, when manufacturing the wiring board 10 which will be described later, it is possible to adhere the first resin layer 4a to the core board 12. In addition, in the insulating sheet 1, the first resin 5a of the first resin layer 4a may maintain to be in A stage, or may be in B stage by proceeding the curing by the heating.

In addition, in the insulating sheet 1, it is desirable that a cure degree of the thermosetting resin of the first resin layer 4a is smaller than a cure degree of the thermosetting resin of the second resin layer 4b. As a result, it is possible to reduce damage or dissolution of the second resin layer 4b due to the solvent of the inorganic insulating sol 3x in the step of (2) while improving an adhesion property of the first resin layer 4a. In the insulating sheet 1, the cure degree of the thermosetting resin of the first resin layer 4a is set to be not less than 1% and not greater than 30%, for example. In addition, in the insulating sheet 1, the cure degree of the thermosetting resin of the second resin layer 4b is set to be not less than 30% and not greater than 80%, for example. In the insulating sheet 1, a ratio of the cure degree of the thermosetting resin of the first resin layer 4a to the cure degree of the thermosetting resin of the second resin layer 4b is set to be not less than 20% and not greater than 50%, for example. In addition, the cure degrees of the thermosetting resins of the first resin layer 4a and the second resin layer 4b are calculated by comparing the results measured using Raman scattering spectroscopy with those of the completely cured thermosetting resins.

Meanwhile, when applying the first varnish on the inorganic insulating layer 3, a part of the first varnish is filled in the second voids V2 through the opening O. Herein, since the first resins 5a is easy to be penetrated in the second voids V2 than the first inorganic insulating filler 6a, it is possible to set the content of the inorganic insulating filler 6a of the resin portion 7 smaller than the first resin layer 4a. In addition, a part of the first varnish is filled in the first voids V1 in the same manner as the second voids V2.

In addition, in the cross section along the thickness direction, if a thickness and a width of the second voids V2 are formed to be larger than the particle size of the second inorganic insulating filler 6b, the first resin layer 4a becomes able to easily penetrate into the second voids V2, and it is possible to adhere the inorganic insulating layer 3 to the resin portion 7 in the second voids V2.

As described above, it is possible to manufacture the insulating sheet 1. By manufacturing the insulating sheet 1 as described above, it is possible to easily form the inorganic insulating layer 3 having high flatness.

Next, a method of manufacturing the wiring board 10 using the insulating sheet 1 will be described in detail.

(Manufacture of Wiring Board)

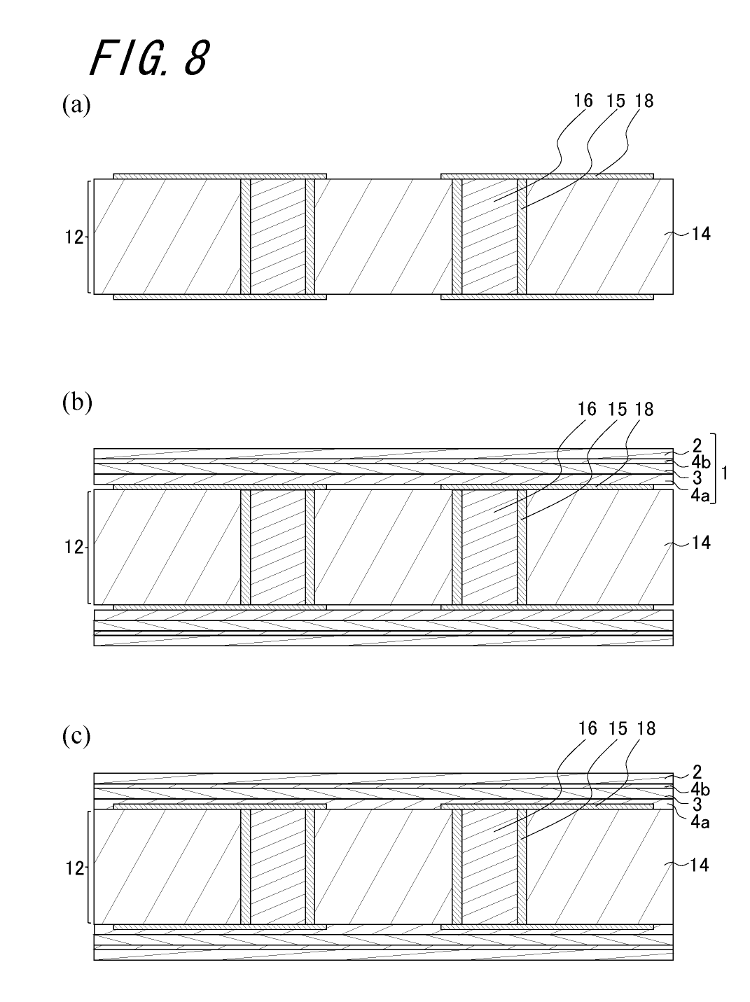

(6) As shown in FIG. 8(a), the core board 12 is manufactured. In detail, this is performed as follows, for example.

First, the resin matrix 14 is manufactured by laminating a plurality of resin sheets including uncured thermosetting resins and base materials, forming a laminated body by laminating metal foil on the outermost layer, heating and pressurizing the laminated body, and curing the uncured resin. Next, through holes are formed on the resin matrix 14 by drilling or laser processing, for example. Then, the tubular through-hole conductors 15 are formed on the inner wall of the through holes, by electroless plating, electroplating, evaporation, CVD or sputtering, for example. Next, the insulator 16 is formed by filling a resin material into the region surrounded by the through-hole conductor 15. Then, after adhering a conductive material to the exposed area of the insulator 16, the metal foil is patterned to form the conductive layer 18 by a well-known photolithography technique or etching method of the related art.

It is possible to manufacture the core board 12 as described above.

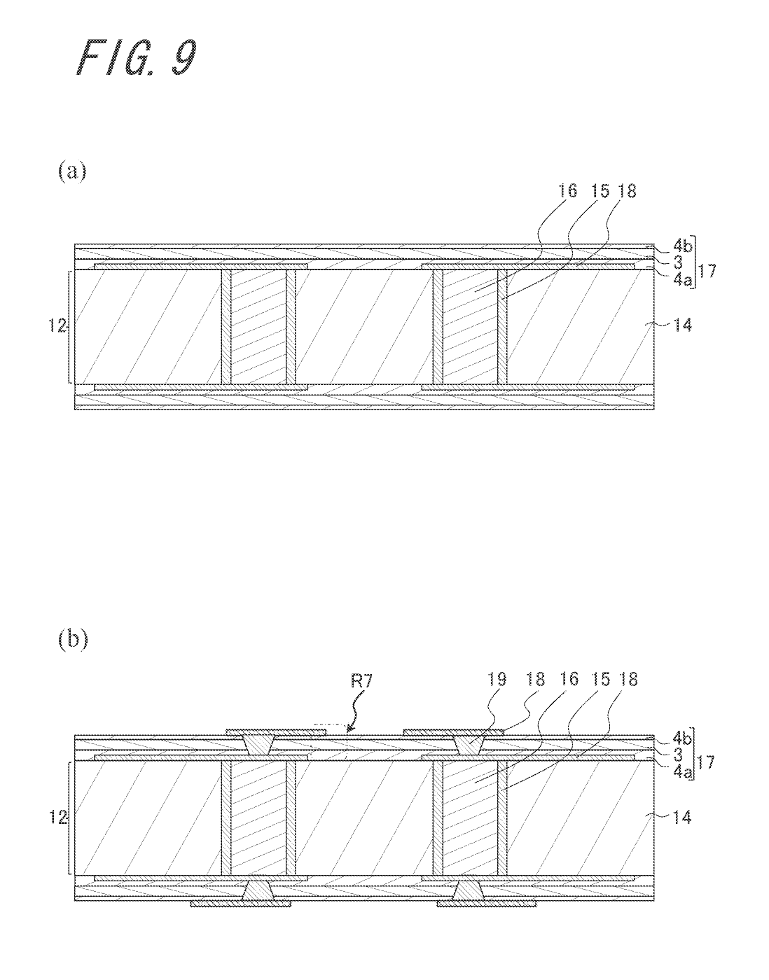

(7) As shown in FIGS. 8(b), 8(c), and 9(a), the insulating layer 17 formed of the first resin layer 4a, the inorganic insulating layer 3, and the second resin layer 4b is formed on the core board 12 using the insulating sheet 1. In detail, this is performed as follows, for example.

First, as shown in FIG. 8(b), the insulating sheet 1 is laminated on the core board 12 (support member) via the first resin layer 4a so that the resin sheet 2 becomes the outermost layer to form a laminated body. Next, as shown in FIG. 8(c), by heating and pressurizing the laminated body along a laminating direction at a temperature of not lower than the curing start temperature of the thermosetting resin included in the first resin layer 4a and less than a melting point of the thermoplastic resin included in the resin sheet 2, the inorganic insulating layer 3 is adhered to the core board 12 via the first resin layer 4a while curing the thermosetting resin of the first resin layer 4a. Then, as shown in FIG. 9(a), by making the first resin layer 4a, the inorganic insulating layer 3, and the second resin layer 4b remain on the core board 12 by peeling off the resin sheet 2 from the inorganic insulating layer 3 to remove the resin sheet 2, the insulating layer 17 is formed on the core board 12.

As described above, by making the inorganic insulating layer 3 having high flatness included in the insulating sheet 1 remain on the core board 12 using the insulating sheet 1 of the embodiment, it is possible to easily form the inorganic insulating layer 3 having high flatness on the core board 12. In addition, since the main surface which comes in contact with the resin sheet 2 having high flatness becomes an exposed main surface of the insulating layer 17, it is possible to improve flatness of the exposed main surface of the insulating layer 17. As a result, in a step of (8) which will be described later, it is possible to finely form the conductive layers 18 on the exposed main surface of the insulating layer 17.

Herein, since the thermosetting resin included in the first resin layer 4a is uncured in the insulating sheet 1, the first resin layer 4a flows by being heated at a temperature of not lower than the curing start temperature of the thermosetting resin. Accordingly, when heating and pressurizing the laminated body, the first resin layer 4a is coated on the side surface and the upper surface of the conductive layers 18 on the core board 12, penetrates between the conductive layers 18, and adheres to the conductive layers 18 and the resin matrix 14. As a result, it is possible that the inorganic insulating layer 3 easily and strongly adheres to the core board 12 via the first resin layer 4a.

In addition, since the resin sheet 2 is a film-like sheet formed of thermoplastic resins and is easy to handle, it is possible to easily perform lamination of the insulating sheet 1 on the core board 12 and peeling of the resin sheet 2 from the inorganic insulating layer 3. Accordingly, it is possible to efficiently perform formation of the inorganic insulating layer 3 on the core board 12.

(8) As shown in FIG. 9(b), the via-conductor 19 is formed on the insulating layer 17 and the conductive layers 18 are formed on the insulating layer 17. In detail, this is performed as follows, for example.

First, a via-hole is formed in the insulating layer 17 and at least a part of the conductive layers 18 is exposed into the via-hole using a YAG laser device or a carbon dioxide laser device, for example. Next, the via-conductor 19 is formed in the via-hole and the conductive layers 18 are formed on the exposed main surface of the insulating layer 17 by a semi-additive method using electroless plating or electroplating. In addition, instead of the semi-additive method, a full-additive method or a subtractive method may be used.

Herein, the second resin layer 4b is arranged on the outermost layer of the insulating layer 17, and the conductive layers 18 are formed on the surface of the second resin layer 4b. As a result, it is possible to easily form the conductive layers 18 having high adhesion strength to the insulating layer 17, compared to a case of forming the conductive layers 18 on the surface of the inorganic insulating layer 3.

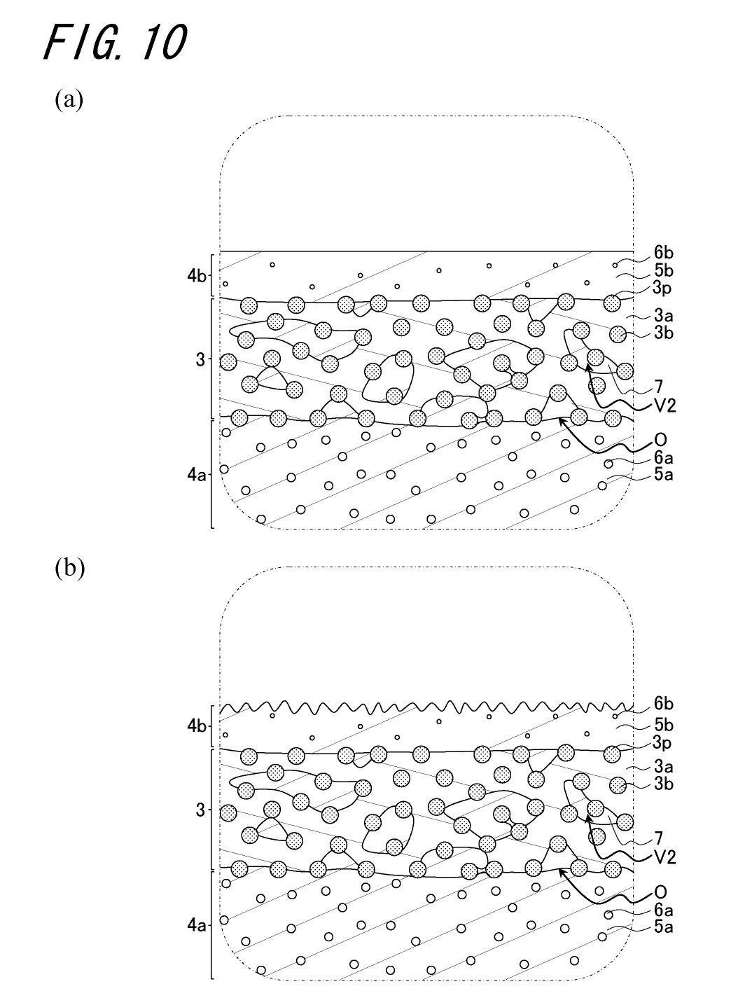

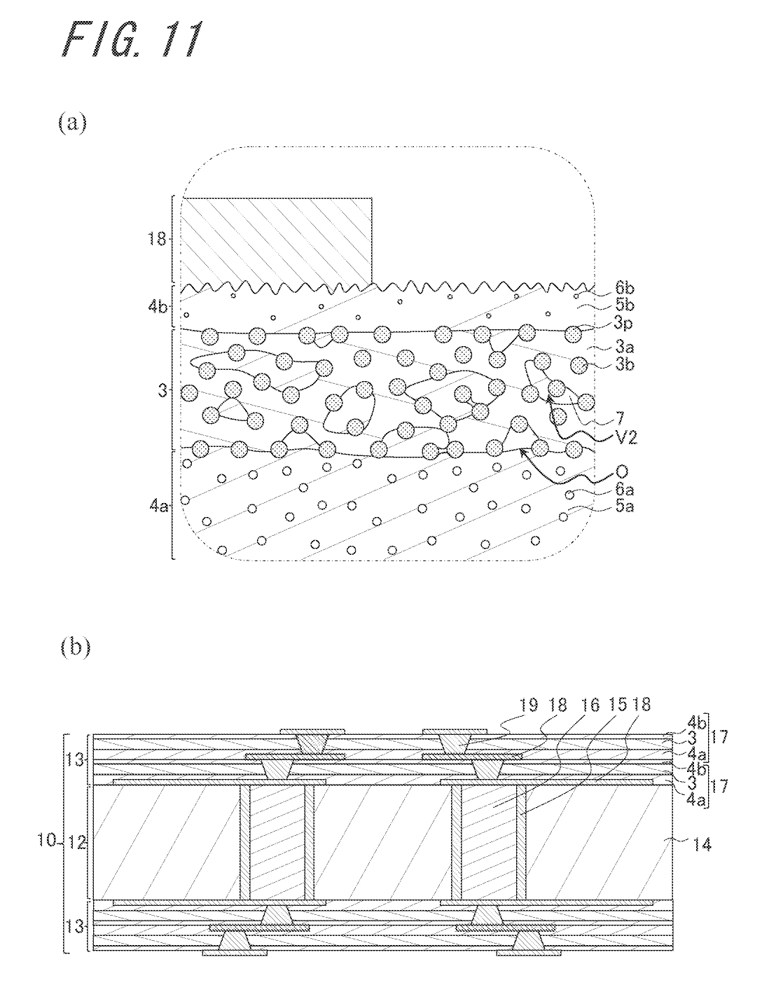

In addition, as shown in FIGS. 10(a), 10(b) and 11(a), it is desirable that the surface of the second resin layer 4b is roughened using a permanganic acid solution before forming the conductive layers 18. As a result, since it is possible to form minute concavity and convexity on the surface of the second resin layer 4b, it is possible to improve adhesion strength of the second resin layer 4b and the conductive layers 18.

(9) As shown in FIG. 11(b), the insulating layer 17 and the conductive layers 18 are alternately laminated and the wiring layer 13 is formed on the top and bottom of the core board 12 by repeating the steps of (7) and (8). In this case, the insulating sheet 1 is laminated on the insulating layer 17 formed on the core board 12 as a support member. In addition, it is possible to obtain the wiring layer 13 in a further multi-layered form by repeating the steps.

As described above, it is possible to manufacture the wiring board 10 using the insulating sheet 1 of the embodiment. It is possible to easily obtain the inorganic insulating layer 3 in a multilayered form by manufacturing the wiring board 10 as described above. In addition, in the wiring layer 13, since it is possible to obtain the inorganic insulating layer 3 having high flatness in a multilayered form, it is possible to improve wiring density of the wiring layer 13.

(Manufacture of Mounting Structure)

(10) It is possible to manufacture the mounting structure 8 shown in FIG. 1, by performing flip-chip-mounting of the electronic component 9 on the wiring board 10 via a bump 4.

### Second Embodiment

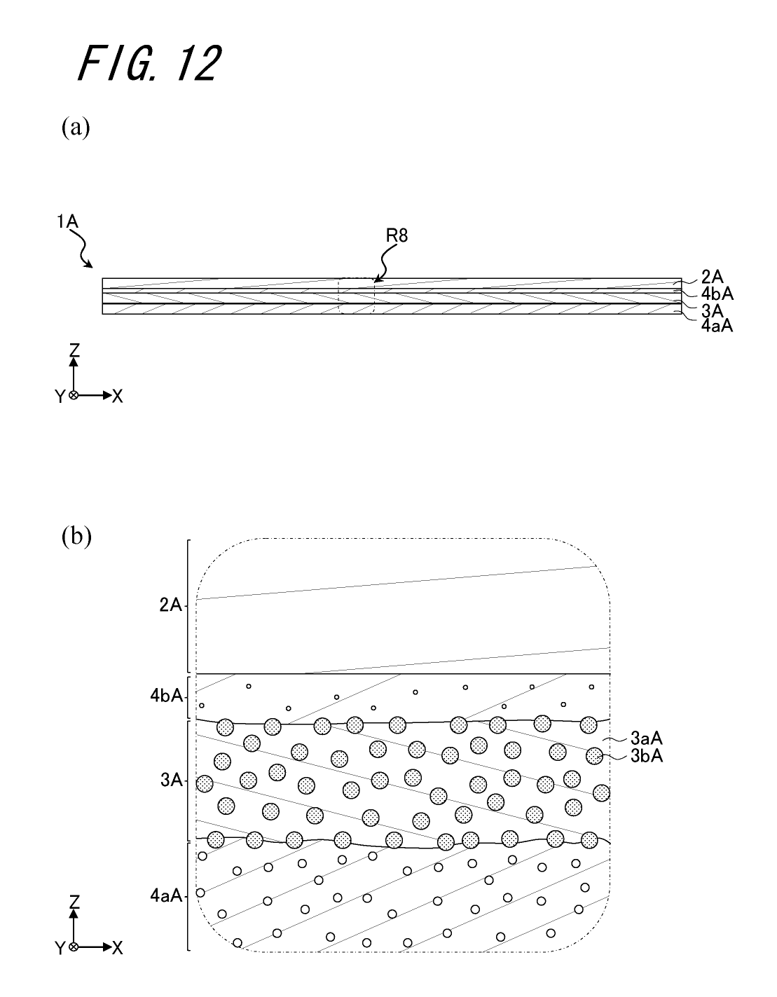

Next, an insulating sheet according to a second embodiment of the invention will be described in detail with reference to FIG. 12. In addition, the same configuration as the first embodiment described above will be omitted.

In an insulating sheet 1A of the embodiment, the configuration thereof is different from the first embodiment, as shown in FIGS. 12(a) and 12(b), and voids and resin portions are not formed on an inorganic insulating layer 3A. In this case, it is possible that the inorganic insulating layer 3A have a low coefficient of thermal expansion, high rigidity, a high insulating property, and a low dielectric loss tangent.

The inorganic insulating layer 3A can be formed as follows, for example.

In the step (2), inorganic insulating sol is prepared so that a solid content of the inorganic insulating sol includes greater than 40% by volume and not greater than 80% by volume of first inorganic insulating particles 3aA and not less than 20% by volume and less than 60% by volume of second inorganic insulating particles 3bA. As a result, in the step (3), it is possible to suppress the formation of voids and to form the inorganic insulating layer 3A by suppressing local contraction of a region surrounded by the second inorganic insulating particles 3bA.

### Third Embodiment

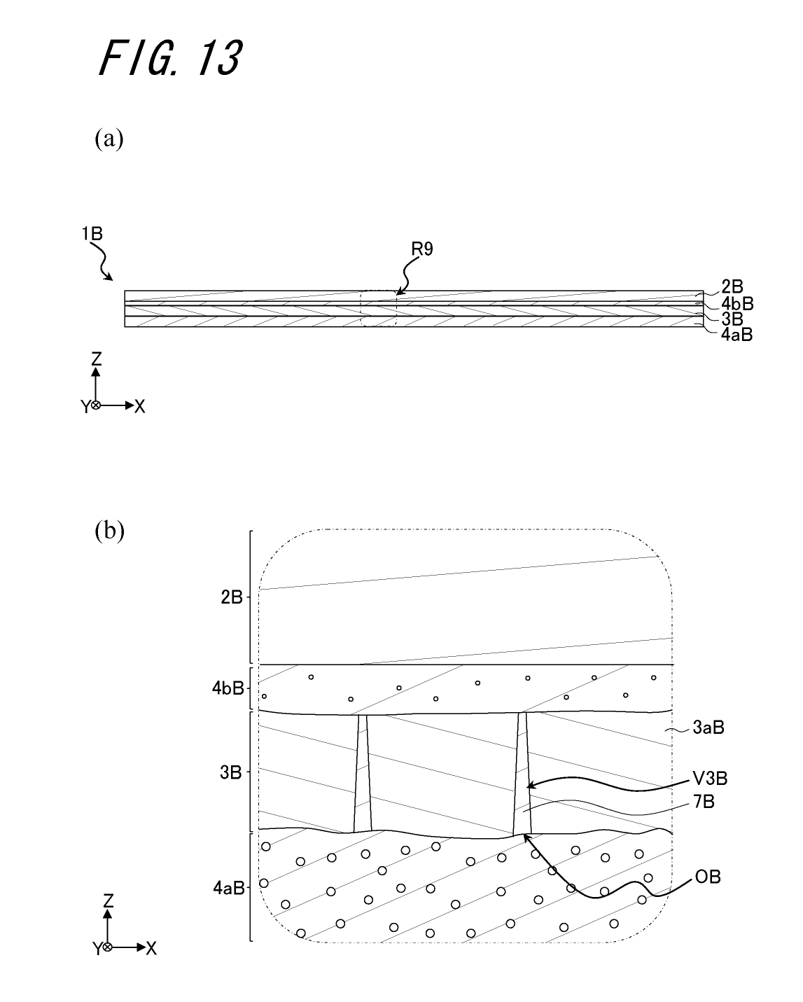

Next, an insulating sheet according to a third embodiment of the invention will be described in detail with reference to FIG. 13. In addition, the same configuration as the first embodiment described above will be omitted.

In an insulating sheet 1B of the embodiment, the configuration thereof is different from the first embodiment, as shown in FIGS. 13(a) and 13(b), and an inorganic insulating layer 3B does not include second inorganic insulating particles and is formed only of first inorganic insulating particles 3aB. As a result, it is possible to improve flatness of the inorganic insulating layer 3B.

In addition, in the insulating sheet 1B of the embodiment, the configuration there of is different from the first embodiment, and in the inorganic insulating layer 3B, third voids V3B which penetrate along the thickness direction are formed and resin portions 7B are arranged on the third voids V3B. As a result, when applying warping stress on the inorganic insulating layer 3B, it is possible to alleviate the stress due to the resin portions 7B and to reduce cracks of the inorganic insulating layer 3B.

It is possible to form the inorganic insulating layer 3B as follows, for example.

In the step (2), inorganic insulating sol in which a solid content is formed of only the first inorganic insulating particles 3aB is prepared. As a result, it is possible to form the inorganic insulating layer 3B formed of only the first inorganic insulating particles 3aB.

In addition, in the step of (4), since the first inorganic insulating particles 3aB contract when bonding to each other, in the inorganic insulating sol coated in a flat plate shape, the solid content formed of only the first inorganic insulating particles 3aB largely contracts along the plan surface direction. As a result, it is possible to form the third voids V3B which penetrate along the thickness direction.

### Fourth Embodiment

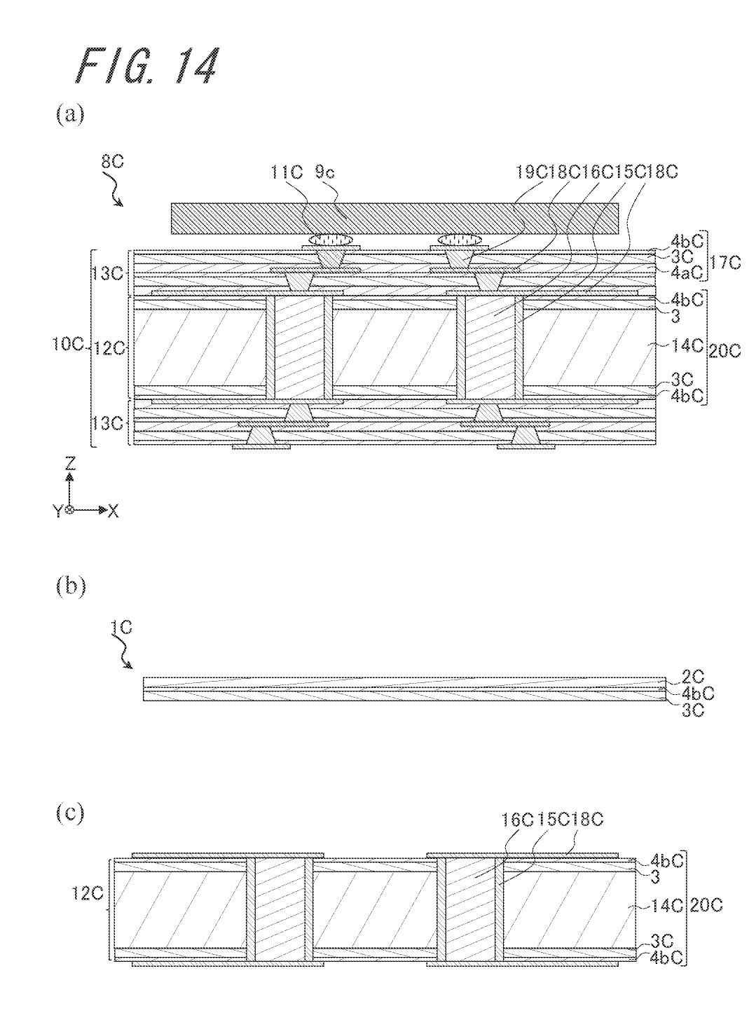

Next, a mounting structure including a wiring board manufactured using an insulating sheet according to a fourth embodiment of the invention will be described in detail with reference to FIG. 14. In addition, description of the same configuration as the first embodiment described above will be omitted.

In a wiring board 10C of the embodiment, the configuration is different from the first embodiment, as shown in FIG. 14(a), and a core board 12C includes a substrate 20C including a resin matrix 14C and inorganic insulating layers 3C arranged on the top and bottom of the resin matrix 14C, and through-hole conductors 15C which penetrate the substrate in a vertical direction. As a result, it is possible to obtain the core board 12C with a low coefficient of thermal expansion, a high insulating property, high rigidity, and a low dielectric loss tangent, by the inorganic insulating layer.

The core board 12C can be formed as follows, for example.

First, as shown in FIG. 14(b), an insulating sheet 1C which does not include a first resin layer is prepared. That is, the insulating sheet 1C is manufactured by not performing the step of (5).

Next, for example, a plurality of resin sheets including the uncured resins are laminated, the insulating sheet 1C is laminated so that the outermost layer becomes the resin sheet 2C to form a laminated body, the laminated body is heated and pressurized to cure uncured resins, and then the resin sheet 2C is removed from the inorganic insulating layer 3C, and thus, the substrate 20C is formed. Next, through holes are formed on the substrate 20C by drilling or laser processing, for example. Then, through-hole conductors 15C are formed on the through holes and the conductive layers 18C are formed on the substrate 20C, by a semi-additive method, a full-additive method, or a subtractive method using electroless plating or electroplating, for example.

As described above, it is possible to form the core board 12C as shown in FIG. 14(c).

The invention is not limited to the embodiments described above, and various modifications, reform, and combinations thereof can be performed without departing from the scope of the invention.

For example, the configuration of the inorganic insulating layer of any one of the first embodiment to the third embodiment described above may be applied to the inorganic insulating layer of the fourth embodiment.

In addition, in the embodiments of the invention, such a configuration that the insulating sheet includes the second resin layer has been described as an example, however, the insulating sheet may not include the second resin layer, or the inorganic insulating layer may be directly formed on the resin sheet, for example. In addition, a release agent formed of silicon resin may be formed between the resin sheet and the second resin layer, for example.

In addition, in the embodiments of the invention, such a configuration that the inorganic insulating layer includes the first inorganic insulating particles and the second inorganic insulating particles has been described as an example, however, inorganic insulating particles having different particle sizes from the first inorganic insulating particles and the second inorganic insulating particles may be included in the inorganic insulating layer.

In addition, in the embodiments of the invention, such a configuration that the first resin is formed of the thermosetting resin has been described as an example, however, a thermoplastic resin may be used as the first resin. As the thermoplastic resin, a fluorine resin, an aromatic liquid crystal polyester resin, a polyether ketone resin, a polyphenylene ether resin, a polyimide resin can be used, for example.

In addition, in the embodiments of the invention, such a configuration that two insulating layers are laminated in the wiring layer, has been described as an example, however, many insulating layers may be laminated.

In addition, in the embodiments of the invention, such a configuration that the resin matrix including the base material as the substrate of the core board is used has been described as an example, however, other substrates may be used as the substrate, a resin matrix which does not include the base material may be used, a ceramic substrate may be used, and a substrate which is obtained by coating a metal plate with a resin may be used.

In addition, in the embodiments of the invention, such a configuration that the inorganic insulating sol is heated in the step of (4) after evaporating the solvent in the step (3), has been described as an example, however, evaporation of solvent and heating of the inorganic insulating sol may be performed at the same time.

In addition, in the embodiments of the invention, such a configuration that the varnish-like first resin layer is coated on the inorganic insulating layer in the step of (5) has been described as an example, however, a sheet-like first resin layer may be laminated on the inorganic insulating layer, and the first resin layer may be formed on the inorganic insulating layer by heating and pressurizing. In this case, a part of the first resin layer is filled in the voids at the time of heating and pressurizing. In addition, in the sheet-like first resin layer, the thermosetting resin is in A stage or B stage, for example.

In the embodiments of the invention, such a configuration that the build-up multilayer wiring board is manufactured using the insulating sheet has been described as an example, however, other types of wiring boards which are to be manufactured using the insulating sheet may be used, and for example, an interposer board, a coreless board without a core board, or a single-layered board formed of only a core board may be used.

In addition, in the embodiments of the invention, the example in which the invention is applied to the wiring board has been described, however, the invention can be applied to any structures including the inorganic insulating layer described above without being limited to the wiring board. For example, the invention can be applied to a case of an electronic device such as a mobile phone. In this case, the inorganic insulating layer is used as a protection film having an abrasion resistance property which protects the case thereof. In addition, the invention can be used for a window which is used in a car or a house. In this case, the inorganic insulating layer can be used as a light-transmitting abrasion-resistant film which is coated on the surface of the window, and as a result, it is possible to suppress the reduction of transparency due to damage on the surface of window material. In addition, the invention can be applied to a mold using a die cast. In this case, the inorganic insulating layer can be used as an abrasion-resistant film or an insulating film which is coated on the surface of the mold.

### REFERENCE SIGNS LIST

1: Insulating sheet

2: Resin sheet

3: Inorganic insulating layer

3a: First inorganic insulating particle

3b: Second inorganic insulating particle

3p: Protrusion portion

4a: First resin layer

4b: Second resin layer

5a: First resin

5b: Second resin

6a: First inorganic insulating filler

6b: Second inorganic insulating filler

7: Resin portion

8: Mounting structure

9: Electronic component

10: Wiring board

11: Conductive bump

12: Core board

13: Wiring layer

14: Resin matrix

15: Through-hole conductor

16: Insulator

17: Insulating layer

18: Conductive layer

19: Via-conductor

V1: First void

V2: Second void

O: Opening

1. An insulating sheet, comprising:
a resin sheet; and
an insulating layer disposed on the resin sheet,
wherein the insulating layer includes an inorganic insulating layer, and
the inorganic insulating layer comprises first inorganic insulating particles which have a particle size of not less than 3 nm and not greater than 110 nm and which are bonded to each other.

2. The insulating sheet according to claim 1,
wherein the resin sheet includes a thermoplastic resin.

3. The insulating sheet according to claim 1,
wherein the insulating layer further includes a first resin layer which is disposed on the inorganic insulating layer and which includes an uncured thermosetting resin.

4. The insulating sheet according to claim 1,
wherein the insulating layer further includes a second resin layer which is disposed between the resin sheet and the inorganic insulating layer.

5. The insulating sheet according to claim 4,
wherein the insulating layer further includes a first resin layer which is disposed on the inorganic insulating layer and which includes an uncured thermosetting resin, and
a thickness of the second resin layer is smaller than a thickness of the first resin layer.

6. The insulating sheet according to claim 5,
wherein the first resin layer includes a first inorganic insulating filler composed of a plurality of particles, and
the second resin layer includes a second inorganic insulating filler composed of a plurality of particles, and a particle size of the plurality of particles of the second inorganic insulating filler is smaller than a particle size of the plurality of particles of the first inorganic insulating filler.

7. The insulating sheet according to claim 1,
wherein the inorganic insulating layer further includes second inorganic insulating particles which are adhered to each other via the first inorganic insulating particles, and a particle size of the second inorganic insulating particles is not less than 0.5 μm and not greater than 5 μm.

8. A method of manufacturing an insulating sheet, comprising:
a step of directly or indirectly applying inorganic insulating sol, including first inorganic insulating particles having a particle size of not less than 3 nm and not greater than 110 nm, onto a resin sheet; and
a step of bonding the first inorganic insulating particles to each other to form an inorganic insulating layer by heating the first inorganic insulating particles at a temperature of lower than a melting point of a resin included in the resin sheet.

9. The method of manufacturing an insulating sheet according to claim 8, further comprising:
a step of forming a resin layer on the resin sheet before applying the inorganic insulating sol,
wherein the resin layer is disposed between the inorganic insulating layer and the resin sheet.

10. A method of manufacturing a structure, comprising:
a step of laminating the insulating sheet according to claim 1 on a support member via a first resin layer including an uncured thermosetting resin so that the resin sheet becomes an outermost layer;
a step of adhering the inorganic insulating layer to the support member via the first resin layer by heating the first resin layer at a temperature of not lower than a curing start temperature of the thermosetting resin and lower than a melting point of a resin included in the resin sheet; and
a step of removing the resin sheet from the inorganic insulating layer.

11. A method of manufacturing a structure comprising:
a step of preparing the insulating sheet according to claim 1;
a step of removing the resin sheet from the insulating layer; and
a step of forming a conductive layer on a main surface of the insulating layer which main surface is disposed on a resin sheet side.

12. The method of manufacturing a structure according to claim 11,
wherein the insulating sheet further includes a second resin layer disposed between the resin sheet and the inorganic insulating layer, and
at the step of forming the conductive layer on the main surface of the insulating layer which main surface was disposed on the resin sheet side, the conductive layer on a main surface of the second resin layer which main surface is disposed on a resin sheet side is formed.
